(19) United States
(12) Patent Application Publication
(10) Pub. No.: US 2011/0022400 A1
(43) Pub. Date: Jan. 27, 2011

(54) AUDIO RESUME PLAYBACK DEVICE AND AUDIO RESUME PLAYBACK METHOD

(75) Inventors: Yukihiko KIMURA, Kyoto (JP); Takashi Yokoyama, Osaka (JP); Tetsuya Oooka, Osaka (JP)

Correspondence Address: McDERMOTT WILL & EMERY LLP, 600 13th Street, N.W., Washington, DC, 20005-3096, US

(73) Assignee: PANASONIC CORPORATION, Osaka (JP)

(21) Appl. No.: 12/847,701

(22) Filed: Jul. 30, 2010

Related U.S. Application Data
(63) Continuation of application No. PCT/JP2008/003674, filed on Dec. 9, 2008.

(30) Foreign Application Priority Data
Jan. 31, 2008 (JP) 2008-020378

(51) Int. Cl. G10L 19/00; G06F 17/00

(52) U.S. Cl. 704/500; 700/94; 704/E19.001

(57) ABSTRACT

An audio playback device includes an interruption-information storage memory which holds frame information at the time of an interruption of playback, a compressed-stream control section which calculates a start position of reading the compressed stream from a recording medium, and reads the compressed stream accordingly, a compressed-stream decode section which decodes the compressed audio stream and transmits decoding information on the frame to the compressed-stream control section as additional resume information, and an output control section which outputs a decoding result. When playback is restarted after an interruption, playback can be restarted without any section not played back in terms of time and without any frequency range not played back, by calculating the start position of reading the compressed stream based on both the additional resume information and the frame information at the time of the interruption, and by reading the compressed stream accordingly.

### CROSS-REFERENCE TO RELATED APPLICATION

This is a continuation of PCT International Application PCT/JP2008/003674 filed on Dec. 9, 2008, which claims priority to Japanese Patent Application No. 2008-020378 filed on Jan. 31, 2008. The disclosures of these applications including the specifications, the drawings, and the claims are hereby incorporated by reference in their entirety.

The present invention relates to audio playback devices and audio playback methods each having a resume playback function to restart playback after an interruption of the playback due to a power-off operation etc., and having special playback functions such as fast-forward, fast-rewind, etc., with respect to a compressed audio stream in which encoding information is multiplexed into a part of encoded frames in a distributed manner and asynchronously.

### BACKGROUND

A configuration and operation of an audio playback device having a conventional resume playback function will be described below using FIGS. 24 and 25.

In FIG. 24, a component 2401 is a recording medium capable of storing a compressed stream generated by organizing a time series of digital audio signals into units of encoded frames. A component 2402 is an interruption-information storage memory for storing as resume information a position to restart when a playback instruction is next received, when playback is interrupted. A component 2403 is a compressed-stream control section which reads the compressed audio stream from the recording medium 2401, stores frame information at the time of interruption to the interruption-information storage memory 2402 when a playback interrupt instruction is received; and when a playback restart instruction is received, reads the resume information from the interruption-information storage memory 2402, determines a start position of reading the compressed stream from the recording medium 2401, and determines a start position of the output. A component 2404 is a compressed-stream decode section capable of decoding the compressed audio stream read by the compressed-stream control section 2403 into digital audio signals, and capable of transmitting the obtained decoding information to the compressed-stream control section 2403.

A resume playback function of a conventional audio playback device provides control such that playback of a compressed stream is restarted at the very same position at whatever position the playback is interrupted, or such that playback is restarted from the beginning of a file if playback is interrupted near the beginning of the file, and playback is restarted from the beginning of a next file if playback is interrupted near the end of a file.

FIG. 25 is an example of a case where playback is restarted at encoded data D(n+3) after playback has been interrupted at the encoded data D(n+3), which is neither near the beginning nor near the end of a file, and another process was performed thereafter.

In FIG. 25, a row 2501 shows frame numbers of encoded frames of a compressed audio stream X. A row 2502 shows the compressed audio stream X of each encoded frame input to the compressed-stream decode section 2404. A row 2503 shows encoding information H applied to each encoded frame. A row 2504 shows a playback frequency range of playback audio signals Y output from the compressed-stream decode section 2404 at each encoded frame. The vertical axis and the horizontal axis of the row 2504 respectively indicate the frequency and the time.

When a compressed audio stream X is input to the compressed-stream decode section 2404, the compressed-stream decode section 2404 extracts encoded data D and encoding information H, and then outputs playback audio signals Y based on the encoded data D and the encoding information H. In this case, since the frames are transmitted to the compressed-stream decode section 2404 starting with a frame having a frame number “n+3,” the encoding information H for decoding the encoded data D(n+3), . . . , D(n+5) respectively having the frame numbers n+3, n+4, and n+5 does not exist in the compressed-stream decode section 2404. Accordingly, since the encoding information H for decoding data having the frame numbers n+3, n+4, and n+5 does not exist, the frequency range of audio signals Y generated by decoding the encoded data D is not extended to F1, but remains at F0.

Note that with respect to the frames having the frame numbers n+7 and n+8 into which encoding information is not multiplexed, encoding information H(n+6) is multiplexed into the preceding encoded data D(n+6), and thus the frequency ranges of audio signals Y(n+7) and Y(n+8), which are decoded from core encoded data, are extended to F1.

Thus, for a compressed stream decoded based on asynchronously-multiplexed encoding information, playback is not guaranteed to restart from a frame into which encoding information is multiplexed; therefore, if playback is restarted at a frame into which no encoding information is multiplexed, an uncomfortable feeling may be felt due to an occurrence of a period without playback, or degradation of audio quality may occur due to playback of only a part of the frequency range which should be played back (see, e.g., FIG. 1 in page 9 of Japanese Patent Publication No. 2005-233980).

In the conventional configuration, when a decoding process is performed on encoded audio signals in which encoding information is multiplexed into a part of encoded frames in a distributed manner and asynchronously to decode and output the playback audio signals, a part or all of the decoding process cannot be performed on encoded frames in which no encoding information is multiplexed and for which no encoding information for decoding process cannot be extracted and applied when playback is restarted after an interruption of playback due to a power-off operation etc., thereby causing the playback audio signals not to be output, or causing the quality of the playback audio signals to be degraded.

### SUMMARY

In order to solve these problems, an audio playback device according to the present invention, capable of playing back a compressed audio stream constructed by multiplexing encoding information asynchronously with respect to encoded frames into a compressed stream generated by organizing a time series of digital audio signals into units of encoded frames, is characterized in that when playback is restarted after an interruption, playback is restarted with a waveform extended to a right frequency range without any section not played back in terms of time, based on information on the compressed audio stream recorded before the interruption.

An audio playback device of the present invention includes a recording medium on which a compressed audio stream is recorded, a compressed-stream control means configured to hold frame information on the compressed audio stream before the interruption of playback, and configured to, when playback is restarted after the interruption, calculate a start position of reading the compressed stream from the recording medium based on additional resume information for determining whether or not a decoded audio frame has encoding information asynchronously multiplexed thereinto, and on the audio frame information, a compressed-stream decode means configured to decode the compressed audio stream read by the compressed-stream control means, to generate the additional resume information based on decoding information obtained by decoding the frames, and to transmit the additional resume information to the compressed-stream control means, and an output control means configured to determine whether a decoding result of the compressed audio stream should be output or not, and to perform an output accordingly.

An audio playback device of the present invention includes a recording medium on which a compressed audio stream is recorded, a compressed-stream control means configured to hold frame information on the compressed audio stream at the time of an interruption of playback, to calculate a start position of reading the compressed audio stream from the recording medium, and to read the compressed audio stream, a compressed-stream decode means configured to decode the compressed audio stream read by the compressed-stream control means, to generate additional resume information so as to include information at least enabling a determination whether a frame into which encoding information is asynchronously multiplexed has been decoded or not, of the decoding information obtained by decoding the frame, and to transmit the additional resume information to the compressed-stream control means, an output control means configured to determine whether a decoding result of the compressed audio stream should be output or not, and to perform an output accordingly, and an interruption-information storage memory configured to store resume information needed to restart playback upon the interruption of playback of the compressed audio stream, where when playback is restarted after the interruption, playback can be restarted without any section not played back in terms of time and without any frequency range not played back, by calculating a start position of reading the compressed audio stream based on both the additional resume information transmitted from the compressed-stream decode means and the frame information at the time of the interruption, and by reading the compressed audio stream from the recording medium.

The compressed-stream control means may include a compressed-stream read control means configured to read the compressed audio stream from the recording medium upon receiving a playback start instruction or a playback restart instruction, and to write information on the stream being played back to the interruption-information storage memory upon receiving a playback interrupt instruction, a start-position-of-playback control means configured to, if interruption information is stored in the interruption-information storage memory, instruct the compressed-stream read control means on a start position of reading the compressed audio stream from the recording medium, and an additional-resume-information write determination section configured to write as appropriate the additional resume information to the interruption-information storage memory if the additional resume information transmitted from the compressed-stream decode means to the interruption-information storage memory includes information enabling a determination whether a frame into which encoding information is asynchronously multiplexed has been decoded or not, where a determination of the start position of reading by the start-position-of-playback control means and a determination of an output-start frame by the output control means may be made upon restart of playback based on the resume information and the additional resume information.

The compressed-stream decode means may include an encoding-information analyze section configured to analyze encoded frames in the compressed audio stream, to extract asynchronously-multiplexed encoding information, to generate the additional resume information by combining either or both of the extracted encoding information or auxiliary decoding information obtained by the encoding information and the frame indices for frames having the asynchronously-multiplexed encoding information with decoding information, and to store the additional resume information to the interruption-information storage memory, a signal processing section configured to perform decoding, and a frame skip circuit configured to discard frames which do not need to be input to the signal processing section, where the frame skip circuit may determine whether or not to perform an input to the signal processing section based on the resume information stored in the interruption-information storage memory and the frame indices for the frames having the asynchronously-multiplexed encoding information in the additional resume information stored in the interruption-information storage memory, and skip and not input into the signal processing section unnecessary encoded frames until the encoded frame corresponding to a frame index for the resume information is input, in order to restart playback from a right position.

In a case of an AAC+SBR stream, the additional resume information may be configured with both the information stored in SBR headers of an AAC+SBR stream extracted in the encoding-information analyze section and the frame indices for frames having the headers, or with the frame indices for frames having the headers.

In a case of an MP3 stream, the additional resume information may be configured with frame indices for encoded frames including beginning portions of main data needed for decoding the frames of an MP3 stream extracted in the encoding-information analyze section, or frame indices for encoded frames having beginning portions of the main data therein.

In order to solve these problems, an audio recording/playback device according to the present invention capable of recording and playing back a compressed audio stream constructed by multiplexing encoding information asynchronously with respect to encoded frames into the compressed stream generated by organizing a time series of digital audio signals into units of encoded frames, includes a recording medium for recording the compressed audio stream is recorded, an encoding-information index table configured to hold indices for frames into which encoding information is multiplexed asynchronously with respect to the encoded frames, a compressed-stream encode means configured to encode the audio signals into the compressed audio stream, and to write frame-position information into the encoding-information index table when multiplexing the encoding information into the compressed stream, a compressed-stream control means configured to calculate a compressed-audio-stream introduction position from both a playback position and the encoding-information index table, a compressed-stream decode means configured to decode the compressed audio stream transmitted by the compressed-stream control means, and an output control means configured to determine whether a decoding result should be output or not, where during playback, playback can be performed without any section not played back in terms of time and without any frequency range not played back even in playback from any position of the compressed audio stream, by controlling with the output control means so that the compressed audio stream transmitted by the compressed-stream control means is decoded by the compressed-stream decode means, and that the decoding result is output starting at a start position of playback.

The compressed-stream decode means may include an encoding-information detection section configured to detect asynchronously-multiplexed encoding information in the compressed audio stream, and to write a frame position thereof to the encoding-information index table, and an index-table determination section configured to determine whether or not index information for the compressed audio stream to be decoded already exists in the encoding-information index table, where the compressed-stream decode means may be configured such that if it is determined by the index-table determination section that index information for the compressed audio stream to be decoded does not exist, playback can be performed without any section not played back in terms of time and without any frequency range not played back in playback from any position of the compressed audio stream during second or later playback, by adding the index information to the encoding-information index table by the encoding-information detection section.

In order to solve these problems, an AV stream playback device according to the present invention capable of playing back a multiplexed AV stream constructed by multiplexing both a compressed audio stream constructed by multiplexing encoding information asynchronously with respect to encoded frames into the compressed stream generated by organizing a time series of digital audio signals into units of encoded frames, and a compressed video stream generated by organizing a time series of digital video data into units of pictures, is characterized in that when playback is restarted after an interruption, playback is restarted with a waveform extended to a right frequency range without any section not played back in terms of time at least for the audio signals based on information on a compressed audio stream recorded before the interruption.

An AV-stream playback device according to the present invention includes a recording medium on which a multiplexed stream is recorded, a multiplexed-AV-stream control means configured to hold frame information on a compressed audio stream before the interruption of playback, and configured to, when playback is restarted after the interruption, calculate a start position of reading the multiplexed AV stream from the recording medium based on additional resume information for determining whether or not a decoded audio frame has encoding information asynchronously multiplexed thereinto, on the audio frame information, and on compressed-video-stream resume information, an AV demultiplexer means configured to demultiplex the multiplexed AV stream read by the multiplexed-AV-stream control means into a compressed audio stream and a compressed video stream, a compressed-audio-stream decode means configured to decode the compressed audio stream demultiplexed by the AV demultiplexer means, and to transmit both the additional resume information generated from decoding information obtained by decoding the frame and the audio frame information to the multiplexed-AV-stream control means, a compressed-video-stream decode means configured to decode the compressed video stream demultiplexed by the AV demultiplexer means, and to transmit the compressed-video-stream resume information to the multiplexed-AV-stream control means, an audio-output control means configured to determine whether a decoding result of the compressed audio stream should be output or not, and to perform an output accordingly, a video-output control means configured to determine whether a decoding result of the compressed video stream should be output or not, and to perform an output accordingly, and an AV synchronization means configured to time-synchronize the decoding result of the compressed audio stream with the decoding result of the compressed video stream.

An AV-stream playback device according to the present invention includes a recording medium on which a multiplexed AV stream is recorded, a multiplexed-AV-stream control means configured to hold each of audio frame information and video frame information at the time of an interruption of playback, to calculate a start position of reading the multiplexed AV stream from the recording medium, and to read the multiplexed AV stream, an AV demultiplexer means configured to demultiplex the multiplexed AV stream read by the multiplexed-AV-stream control means into a compressed audio stream and a compressed video stream, a compressed-audio-stream decode means configured to decode the compressed audio stream demultiplexed by the AV demultiplexer means, to generate additional resume information so as to include information at least enabling a determination whether a frame into which encoding information is asynchronously multiplexed has been decoded or not, of the decoding information obtained by decoding the frame, and to transmit the additional resume information to the multiplexed-AV-stream control means, a compressed-video-stream decode means configured to decode the compressed video stream demultiplexed by the AV demultiplexer means, and to transmit the compressed-video-stream resume information to the multiplexed-AV-stream control means, an audio-output control means configured to determine whether a decoding result of the compressed audio stream should be output or not, and to perform an output accordingly, a video-output control means configured to determine whether a decoding result of the compressed video stream should be output or not, and to perform an output accordingly, an AV synchronization means configured to synchronize the decoding result of the compressed audio stream with the decoding result of the compressed video stream, and an interruption-information storage memory configured to, upon an interruption of playback of the multiplexed AV stream, store both the compressed-audio-stream resume information needed for restart of playback of the compressed audio stream and the compressed-video-stream resume information needed for restart of playback of the compressed video stream, where when playback is restarted after the interruption, playback can be restarted without any section not played back in terms of time and without any frequency range not played back with respect to at least resume playback of audio streams, by calculating a position of the multiplexed AV stream including an audio frame needed for restart of playback based on both the additional resume information transmitted from the compressed-audio-stream decode means and the frame information at the time of the interruption, and by reading the multiplexed AV stream from the recording medium.

The multiplexed-AV-stream control means may include a multiplexed-AV-stream read control means configured to read the multiplexed AV stream from the recording medium upon receiving a playback start instruction or a playback restart instruction, and to write information of the stream being played back to the interruption-information storage memory upon receiving a playback interrupt instruction, a start-position-of-playback control means configured to, if interruption information is stored in the interruption-information storage memory, instruct the multiplexed-AV-stream read control means on a start position of reading the multiplexed AV stream from the recording medium, and an additional-resume-information write determination section configured to write as appropriate the additional resume information to the interruption-information storage memory if the additional resume information transmitted from the compressed-audio-stream decode means to the interruption-information storage memory with respect to resume playback information of a compressed audio stream includes information enabling a determination whether a frame into which encoding information is asynchronously multiplexed has been decoded or not, where a determination of the start position of reading by the start-position-of-playback control means and a determination of an output-start frame by the audio-output control means may be made upon restart of playback based on the compressed-audio-stream resume information and the additional resume information with respect to at least resume playback of audio.

The compressed-audio-stream decode means may include an encoding-information analyze section configured to analyze encoded audio frames, to extract asynchronously-multiplexed encoding information, to generate the additional resume information by combining either or both of the extracted encoding information or auxiliary decoding information obtained by the encoding information and the frame indices for frames having the asynchronously-multiplexed encoding information with decoding information, and to store the additional resume information to the interruption-information storage memory, a signal processing section configured to perform decoding, and a frame skip circuit configured to discard frames which do not need to be input to the signal processing section, where the frame skip circuit may determine whether or not to perform an input to the signal processing section based on the resume information stored in the interruption-information storage memory and the frame index for the frame having the asynchronously-multiplexed encoding information in the additional resume information stored in the interruption-information storage memory, and skip and not input into the signal processing section unnecessary encoded frames until the encoded frame corresponding to a frame index for the resume information is input, in order to restart playback from a right position.

According to the present invention, since a decoding process can be performed based on asynchronously-multiplexed encoding information even when an instruction is provided to restart playback at an encoded frame into which no encoding information is multiplexed in a case where a decoding process is performed from an encoded frame in the middle of a time series of successive encoded frames, or in a case where a decoding process is performed on a limited number of encoded frames in fast-forwarding playback, it is possible to prevent an uncomfortable feeling due to an occurrence of a period of no playback and a rapid change in audio quality due to an occurrence of a frequency range not played back until reaching a frame into which encoding information is multiplexed. In addition, playback can be performed without an occurrence of a period of no playback as well as a frequency range not played back also in resume playback and fast-forward playback for a plurality of streams and a plurality of users by recording the interruption information in association with ID's of the streams and ID's of the users, respectively.

### BRIEF DESCRIPTION OF THE DRAWINGS

FIG. 1 is a block diagram illustrating a configuration of an audio playback device according to the first embodiment.

FIG. 2 is a block diagram illustrating a configuration of an audio playback device according to the second embodiment.

FIG. 3 is a diagram illustrating a compressed audio stream and encoding information applied to each of the encoded frames according to the second embodiment.

FIG. 4 is a diagram illustrating an example configuration of the additional resume information according to the second embodiment.

FIG. 5 is a block diagram illustrating a configuration of an audio playback device according to the third embodiment.

FIG. 6 is a diagram illustrating a compressed audio stream and encoding information applied to each of the encoded frames according to the third embodiment.

FIG. 7 is a diagram illustrating a compressed audio stream and encoding information applied to each of the encoded frames upon restart of playback according to the third embodiment.

FIG. 8 is a block diagram illustrating a configuration of an audio playback device according to the fourth embodiment.

FIG. 9 is a diagram illustrating a compressed audio stream and encoding information applied to each of the encoded frames upon restart of playback according to the fourth embodiment.

FIG. 10 is a diagram illustrating an example configuration of the additional resume information according to the fifth embodiment.

FIG. 11 is a block diagram illustrating a configuration of an audio recording/playback device according to the sixth embodiment.

FIG. 12 is a diagram for illustrating a method of playing back a compressed audio stream recorded by an audio recording/playback device according to the sixth embodiment.

FIG. 13 is a block diagram illustrating a configuration of an audio recording/playback device according to the seventh embodiment.

FIG. 14 is a set of diagrams illustrating relationships between encoding-information index tables and compressed streams according to the seventh embodiment.

FIG. 15 is a diagram illustrating a compressed-audio playback method according to the seventh embodiment.

FIG. 16 is a diagram illustrating an example configuration of an audio playback apparatus according to the eighth embodiment.

FIG. 17 is a block diagram illustrating a configuration of an AV-stream playback device according to the ninth embodiment.

FIG. 18 is a diagram illustrating a multiplexed AV stream, a compressed video stream and a compressed audio stream demultiplexed from the multiplexed AV stream, and encoding information applied to each of the encoded frames according to the ninth embodiment.

FIG. 19 is a diagram illustrating an example configuration of the additional resume information according to the ninth embodiment.

FIG. 20 is a block diagram illustrating a configuration of an AV-stream playback device according to the tenth embodiment.

FIG. 21 is a block diagram illustrating a configuration of an AV-stream playback device according to the eleventh embodiment.

FIG. 22 is a block diagram illustrating a configuration of an AV-stream playback device according to the twelfth embodiment.

FIG. 23 is a diagram illustrating an example configuration of an AV-stream playback apparatus according to the thirteenth embodiment.

FIG. 24 is a block diagram illustrating a configuration of a conventional audio playback device.

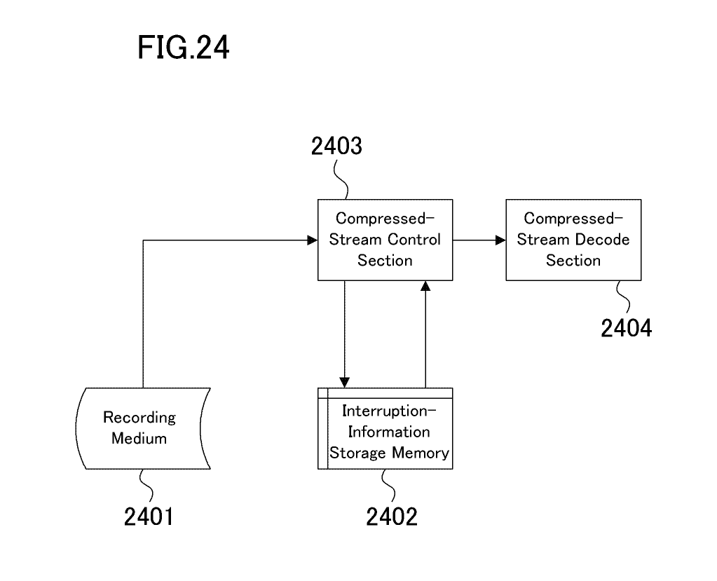

FIG. 25 is a diagram illustrating a compressed audio stream, encoding information for each of the encoded frames, and the frequency of an output waveform upon restart of playback with respect to a conventional audio playback device.

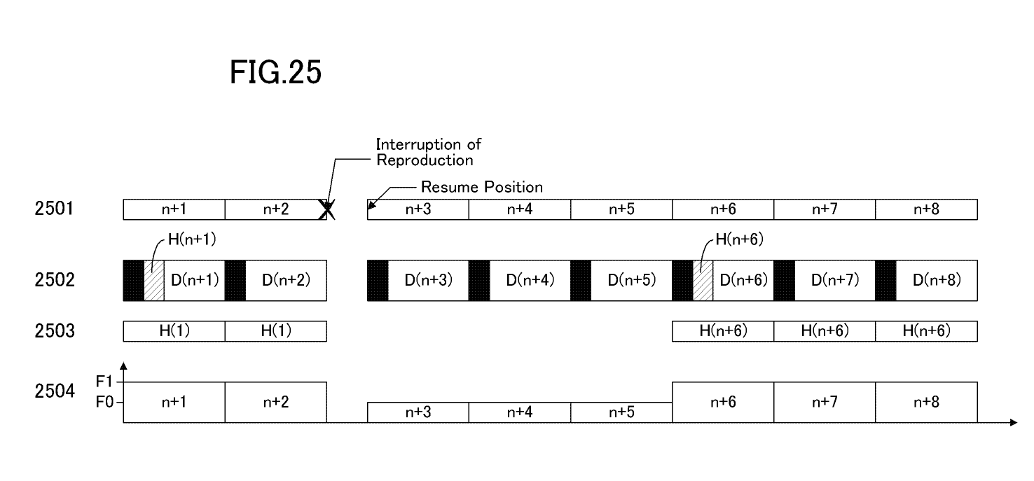

### DETAILED DESCRIPTION

### First Embodiment

First, an audio playback device according to the first embodiment of the present invention will be described below with reference to the drawings.

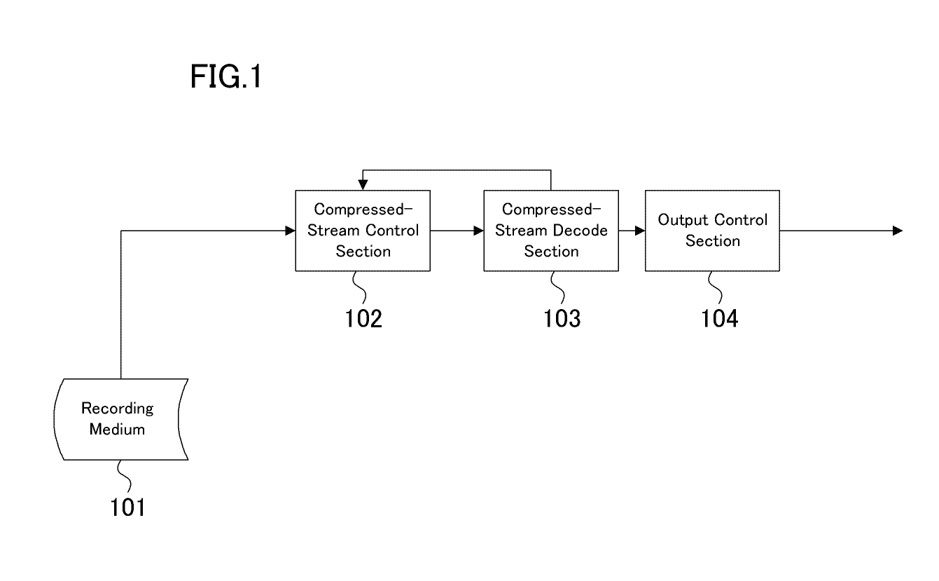

FIG. 1 is a block diagram illustrating a configuration of an audio playback device according to the first embodiment. In FIG. 1, a component 101 is a recording medium capable of storing a compressed stream generated by organizing a time series of digital audio signals into units of encoded frames. A component 102 is a compressed-stream control section which holds frame information before an interruption of playback, and when playback is restarted after the interruption, calculates a start position of reading the compressed stream from the recording medium 101 based on additional resume information for determining whether or not a decoded frame has information asynchronously multiplexed thereinto, and on the frame information. A component 103 is a compressed-stream decode section which decodes the compressed audio stream read by the compressed-stream control section 102 into digital audio signals, generates the additional resume information based on obtained decoding information, and transmits the additional resume information to the compressed-stream control section 102. A component 104 is an output control section which provides an output along with mute control and fade control according to a decoding result.

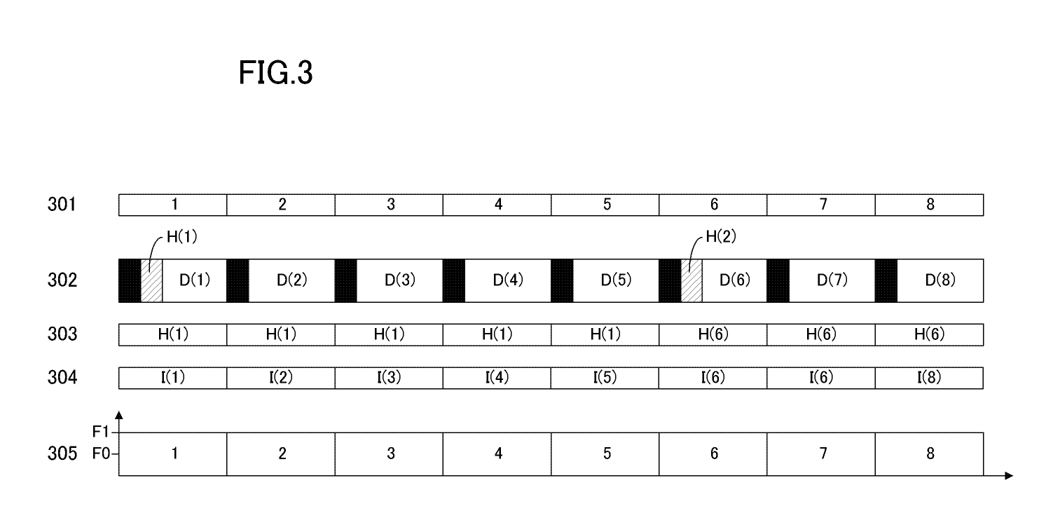

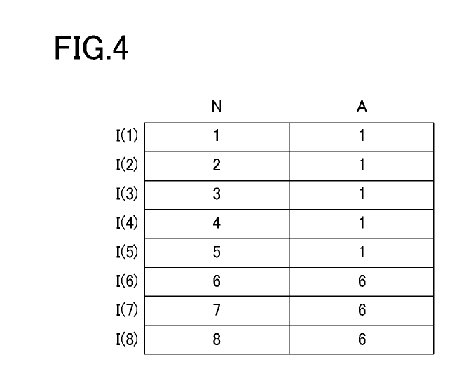

The basic operation of this audio playback device will be described below using FIGS. 3 and 4.

FIG. 3 illustrates a relationship over time between a compressed audio stream X input to the audio playback device and encoding information H needed to decode the compressed audio stream X into digital audio signals Y. In FIG. 3, a row 301 shows frame numbers of encoded frames of the compressed audio stream X. A row 302 shows the compressed audio stream X of each encoded frame. A row 303 shows the encoding information H utilized for each encoded frame. A row 304 shows the additional resume information I(n) [n=1, 2, 3, . . . ] generated by the compressed-stream decode section 103 for each encoded frame. A row 305 shows the playback digital audio signals Y output from the compressed-stream decode section 103 at each encoded frame. The vertical axis and the horizontal axis of the row 305 respectively indicate the frequency and the time.

As shown in FIG. 3, the compressed audio stream X includes encoded data D(m) └m=1, 2, 3, . . . ┘ and encoding information H(n) └n=1, 2, 3, . . . ┘.

The compressed-stream control section 102 outputs encoded data D of a frame number specified by a frame index N to the compressed-stream decode section 103. For example, if the frame index N specifies a frame number “1,” then the compressed-stream control section 102 outputs the encoded data D(1) corresponding to the frame number “1” to the compressed-stream decode section 103.

The compressed-stream decode section 103 extracts the encoding information H upon decoding the compressed audio stream X. Then, the compressed-stream decode section 103 generates the additional resume information I(n) which associates the encoding information H with the frame indices N for the encoded frames, and transmits the additional resume information I(n) to the compressed-stream control section 102.

FIG. 4 shows an example configuration in which the additional resume information I(n) includes encoding-information frame indices A associated with the encoding information H and frame indices N for the encoded frames which have been decoded. The compressed-stream control section 102 holds the additional resume information I(n) at the time of receiving a playback interrupt instruction, of the additional resume information transmitted at every frame; and upon receiving a playback restart instruction, the compressed-stream control section 102 reads information from the additional resume information I(n), and transmits frames to the compressed-stream decode section 103, starting with a frame matching an encoding-information frame index A stored as the start position of reading the compressed-stream. This allows the playback audio signals Y(2)-Y(5) to be output with a waveform having a right frequency range extended to a frequency range F1 even when playback is restarted at encoded data D(m) [m=2, 3, 4, and 5] into which encoding information H is not multiplexed.

### Second Embodiment

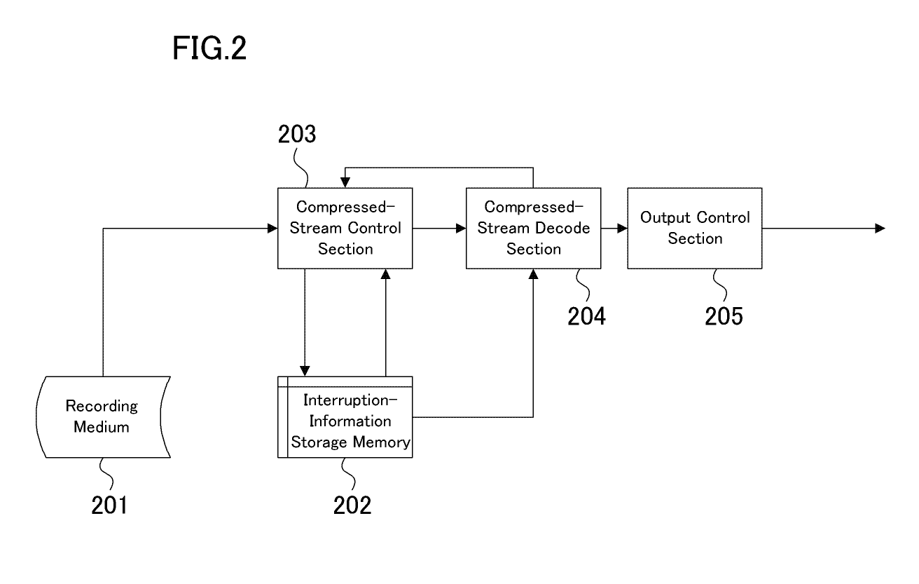

FIG. 2 is a block diagram illustrating a configuration of an audio playback device according to the second embodiment. In FIG. 2, a component 201 is a recording medium capable of storing a compressed stream generated by organizing a time series of digital audio signals into units of encoded frames. A component 202 is an interruption-information storage memory for storing as resume information a position to restart when a playback instruction is next received, when playback is interrupted. It is preferable that the interruption-information storage memory 202 be formed of a non-volatile memory so that no information is lost upon a power-off operation etc. A component 203 is a compressed-stream control section which reads the compressed audio stream from the recording medium 201, stores frame information at the time of interruption to the interruption-information storage memory 202 when a playback interrupt instruction is received; and when a playback restart instruction is received, reads the resume information from the interruption-information storage memory 202, determines a start position of reading the compressed stream from the recording medium 201, and determines a start position of the output. A component 204 is a compressed-stream decode section capable of decoding the compressed audio stream read by the compressed-stream control section 203 into digital audio signals, and capable of transmitting the obtained decoding information to the compressed-stream control section 203. A component 205 is an output control section which provides an output along with mute control and fade control according to a decoding result.

The basic operation of this audio playback device will be described below using FIGS. 3 and 4.

FIG. 3 illustrates a relationship over time between a compressed audio stream X input to the audio playback device and encoding information H needed to decode the compressed audio stream X into digital audio signals Y. In FIG. 3, a row 301 shows frame numbers of encoded frames of the compressed audio stream X. A row 302 shows the compressed audio stream X of each encoded frame. A row 303 shows the encoding information H utilized for each encoded frame. A row 304 shows the additional resume information I(n) [n=1, 2, 3, . . . ] generated by the compressed-stream decode section 204 for each encoded frame. A row 305 shows the playback digital audio signals Y output from the compressed-stream decode section 204 at each encoded frame. The vertical axis and the horizontal axis of the row 305 respectively indicate the frequency and the time.

As shown in FIG. 3, the compressed audio stream X includes encoded data D(m) [m=1, 2, 3, . . . ] and encoding information H(n) [n=1, 2, 3, . . . ].

The compressed-stream control section 203 outputs encoded data D having a frame number specified by a frame index N to the compressed-stream decode section 204. For example, if the frame index N specifies a frame number “1,” then the compressed-stream control section 203 outputs the encoded data D(1) corresponding to the frame number “1” to the compressed-stream decode section 204.

The compressed-stream decode section 204 extracts the encoding information H upon decoding the compressed audio stream X. Then, the compressed-stream decode section 204 generates the additional resume information I(n) which associates the encoding information H with the frame indices N for the encoded frames, and transmits the additional resume information I(n) to the compressed-stream control section 203.

FIG. 4 shows an example configuration in which the additional resume information I(n) includes encoding-information frame indices A associated with the encoding information H and the frame indices N for the encoded frames which have been decoded. The compressed-stream control section 203 writes the additional resume information I(n) transmitted at every frame to the interruption-information storage memory 202; and upon receiving a playback interrupt instruction, the compressed-stream control section 203 writes the frame index N of the encoded frame at the time of receiving the interrupt instruction. The interruption-information storage memory 202 stores encoding-information frame index A as a start position of reading the compressed-stream, and the frame index N as a position of output-start frame.

When a playback restart instruction is received, the compressed-stream control section 203 reads information from the interruption-information storage memory 202, and transmits frames to the compressed-stream decode section 204, starting with a frame matching an encoding-information frame index A stored as the start position of reading the compressed-stream. This allows the playback audio signals Y(2)-Y(5) to be output with a waveform having a right frequency range extended to a frequency range F1 even when playback is restarted at encoded data D(m) [m=2, 3, 4, and 5] into which encoding information H is not multiplexed.

### Third Embodiment

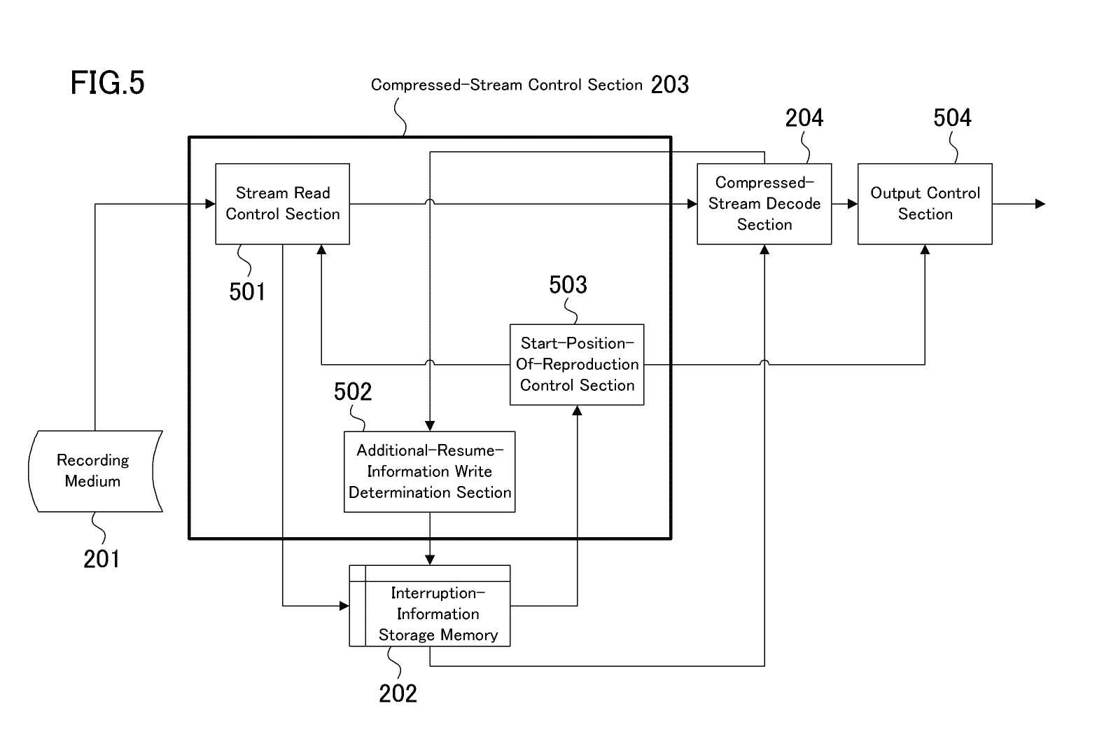

FIG. 5 is a block diagram illustrating a configuration of an audio playback device according to the third embodiment.

A component 504 is an output control section, which is a modification of the output control section 205 of FIG. 1, capable of controlling whether or not to output the playback digital audio signals decoded by the compressed-stream decode section 204 as sound according to an instruction of a start-position-of-playback control section 503.

The compressed-stream control section 203 includes a stream read control section 501, an additional-resume-information write determination section 502, and a start-position-of-playback control section 503. The stream read control section 501 reads and transmits a compressed audio stream from the recording medium 201 to the compressed-stream decode section 204. The additional-resume-information write determination section 502 analyzes additional resume information I(n) generated by the compressed-stream decode section 204, and writes the additional resume information I(n) to the interruption-information storage memory 202 only if the encoding-information frame index A matches the frame index N. The start-position-of-playback control section 503 reads resume information from the interruption-information storage memory 202, instructs the stream read control section 501 to read frames starting with a frame indicated by an encoding-information frame index A, and instructs the output control section 504 to start outputting frames starting with a frame indicated by a frame index N.

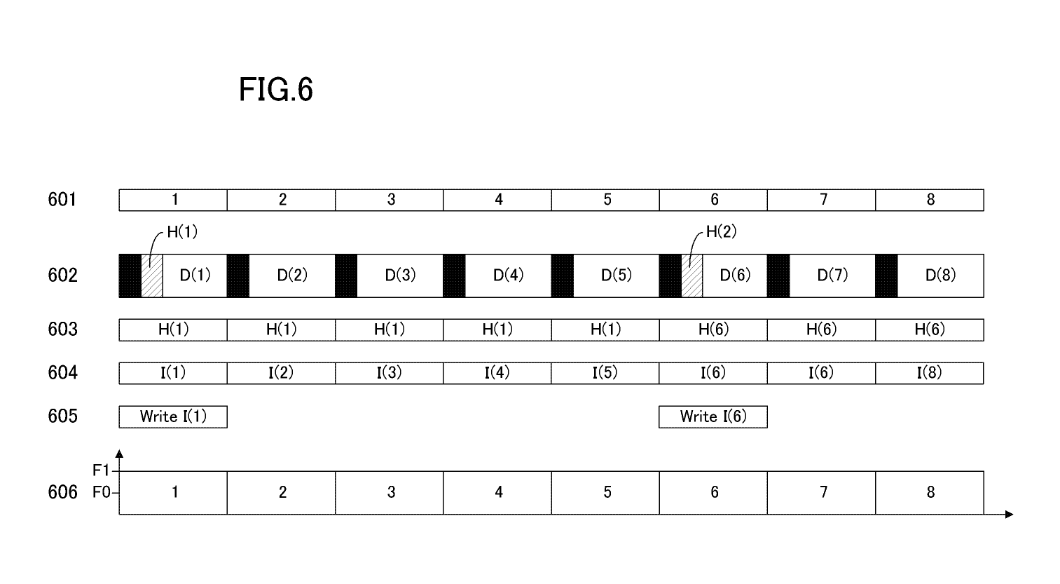

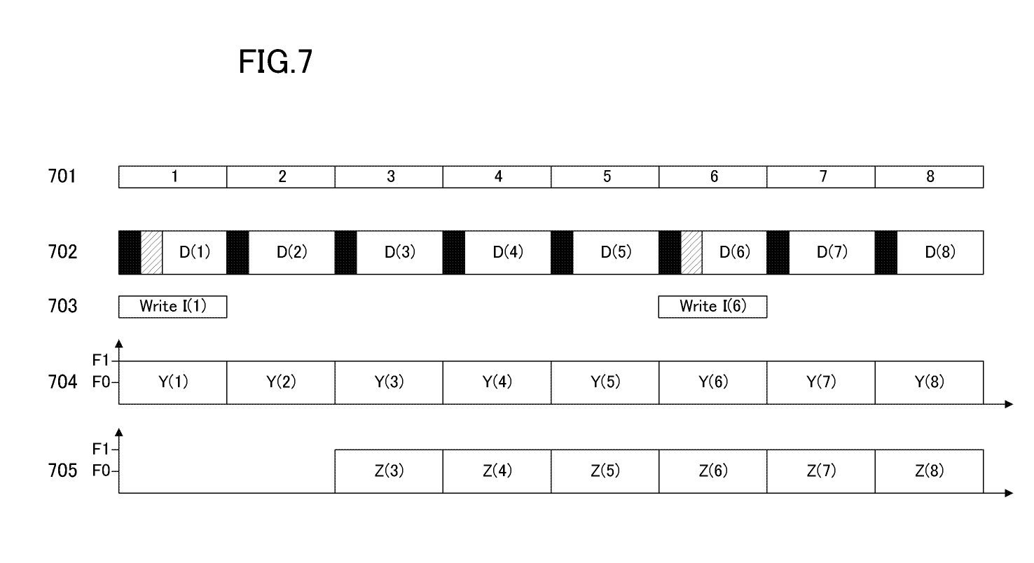

The operation of the audio playback device according to this embodiment will be described below using FIGS. 6 and 7.

In FIG. 6, a row 601 shows frame numbers of encoded frames of the compressed audio stream X. A row 602 shows the compressed audio stream X of each encoded frame. A row 603 shows the encoding information H utilized for each encoded frame. A row 604 shows the additional resume information I(n) generated by the compressed-stream decode section 204 for each encoded frame. A row 605 shows the timings when the additional resume information I(n) is written into the interruption-information storage memory 202 by the additional-resume-information write determination section 502. A row 606 shows the playback digital audio signals Y output from the compressed-stream decode section 204 at each encoded frame. The vertical axis and the horizontal axis of the row 606 respectively indicate the frequency and the time.

As shown in FIG. 6, while the additional resume information I(n) is generated by the compressed-stream decode section 204 for each encoded frame, the write operation to the interruption-information storage memory 202 is performed only if a frame into which the encoding information H is multiplexed has been decoded, thereby reducing the bus load with respect to the interruption-information storage memory 202.

FIG. 7 shows an example in which playback is restarted at encoded data D(3) into which encoding information is not multiplexed. In FIG. 7, a row 701 shows frame numbers of encoded frames of the compressed audio stream X. A row 702 shows the compressed audio stream X of each encoded frame. A row 703 shows the timings when the additional resume information I(n) is written into the interruption-information storage memory 202. A row 704 shows decoded signals Y transmitted from the compressed-stream decode section 204 to the output control section 504 at each encoded frame. A row 705 shows the playback digital audio signals Z output from the output control section 504 to the outside. The vertical axes and the horizontal axes of the rows 704 and 705 respectively indicate the frequency and the time.

As shown in FIG. 7, encoded data are transmitted to the compressed-stream decode section 204 starting with the encoded data D(1) corresponding to a frame index indicated in the additional resume information I(n) read from the interruption-information storage memory 202, thus the decoded signals Y(1) and Y(2), respectively corresponding to the encoded data D(1) and D(2), are transmitted to the output control section 504; however, the start-position-of-playback control section 503 instructs the output control section 504 to output decoded signals starting from the decoded signal Y(3), corresponding to D(3), as a playback audio signal, thereby allowing the playback digital audio signals Z to be output starting at a right restart position Z(3) without outputting unnecessary decoded signals Y(1) and Y(2), with a waveform having a right frequency range extended to a frequency range F1.

### Fourth Embodiment

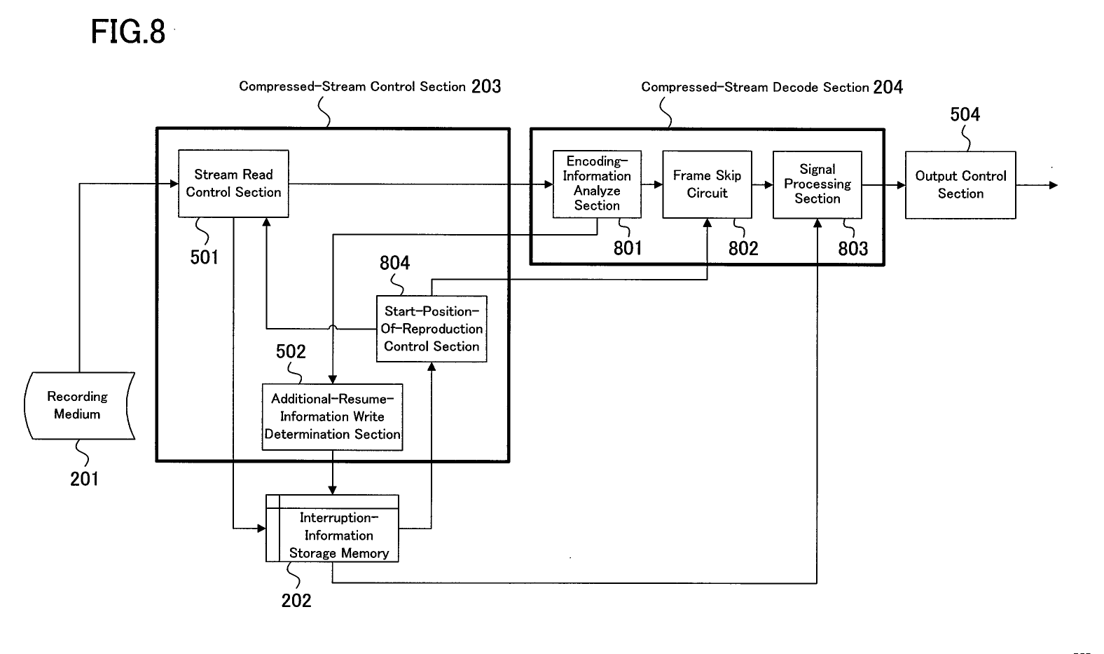

FIG. 8 is a block diagram illustrating a configuration of an audio playback device according to the fourth embodiment. In FIG. 8, a component 804 is a start-position-of-playback control section, which is provided instead of the start-position-of-playback control section 503 of FIG. 5, capable of notifying the compressed-stream decode section 204 of a playback-start frame.

The compressed-stream decode section 204 includes an encoding-information analyze section 801, a frame skip circuit 802, and a signal processing section 803. The encoding-information analyze section 801 analyzes the compressed audio stream, extracts and stores encoding information in advance, and generates additional resume information I(n). The frame skip circuit 802 determines whether each frame is an unnecessary frame or not based on both an instruction from the start-position-of-playback control section 804 and the encoding information extracted in the encoding-information analyze section 801; and if unnecessary, the frame skip circuit 802 controls so that the encoded data are not supplied to the signal processing section 803. The signal processing section 803 performs signal processing on and decoding of the encoded data.

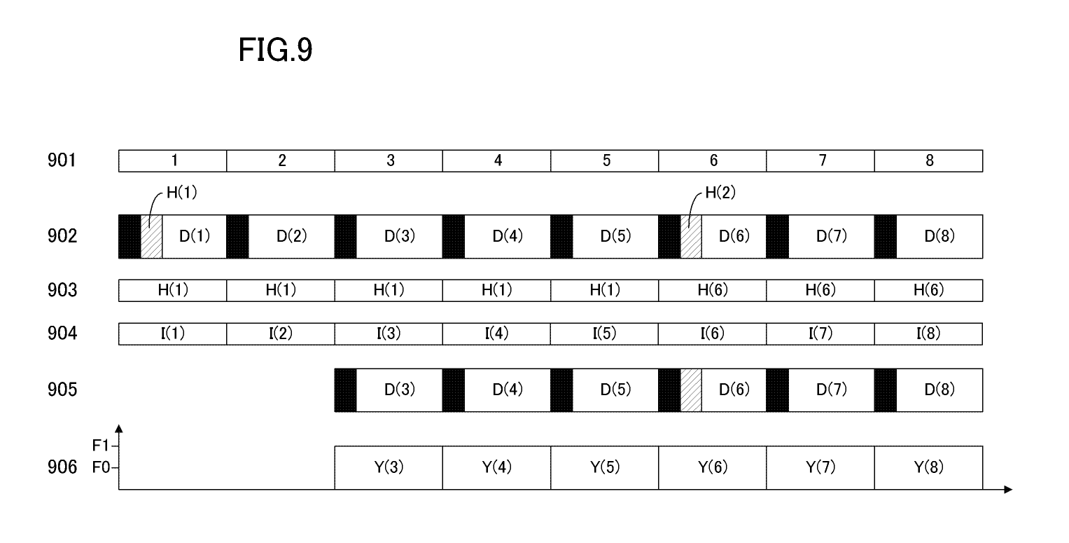

The operation of the audio playback device according to this embodiment will be described below using FIG. 9.

FIG. 9 illustrates an operation over time in which playback is restarted at encoded data D(3). In FIG. 9, a row 901 shows frame numbers of encoded frames of the compressed audio stream X. A row 902 shows the compressed audio stream X of each encoded frame transmitted to the compressed-stream decode section 204 after playback is restarted. A row 903 shows the encoding information H utilized for each encoded frame. A row 904 shows the additional resume information I(n) generated by the encoding-information analyze section 801 for each encoded frame. A row 905 shows the compressed audio stream X of each encoded frame transmitted to the signal processing section 803. A row 906 shows the playback digital audio signals Y decoded by the signal processing section 803 after the frame skip circuit 802 determines whether each frame is an unnecessary frame or not. The vertical axis and the horizontal axis of the row 906 respectively indicate the frequency and the time.

As shown in FIG. 9, although encoded data are sequentially transmitted to the compressed-stream decode section 204 starting with the encoded data D(1) corresponding to a frame index indicated in the additional resume information I(n), the encoded data D(1) and D(2) are skipped by the frame skip circuit 802 as unnecessary frames; thus, encoded data are transmitted to the signal processing section 803 from the encoded data D(3), which is a playback-restart frame, thereby allowing the playback audio signals Y to be output starting at a right restart position Z(3) without decoding the unnecessary frames D(1) and D(2), with a waveform having a right frequency range extended to a frequency range F1, and also allowing the processing load of signal processing to be reduced.

### Fifth Embodiment

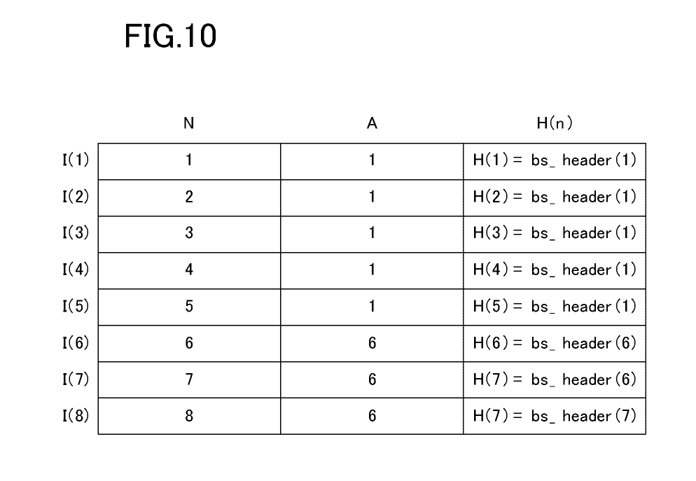

FIG. 10 shows an example configuration of additional resume information I(n) according to the fifth embodiment, and is a diagram illustrating the additional resume information I(n) which includes both encoding-information frame indices A and encoding information H, as an example in which the input compressed audio stream is in AAC+SBR format.

In FIG. 10, the additional resume information I(n) uses frame indices for encoded frames including SBR headers as the encoding-information frame indices A, and has the encoding information H including parameters used for extending frequency of the playback digital audio signals Y obtained by analyzing the SBR headers. When using a configuration as shown in FIG. 10, the encoding information H may be directly extracted from the interruption-information storage memory 202 and be used in the compressed-stream decode section 204, and stream transmission to the compressed-stream decode section 204 may be restarted at the interrupted frame.

While this embodiment has been described using AAC+SBR as an example, and the additional resume information I(n) has been described as including both the encoding-information frame indices A and the encoding information H, the additional resume information I(n) may be constructed only with the encoding-information frame indices A for reduction in memory. Also in a case of MP3, playback can be restarted at a right position, in a similar manner, by generating the additional resume information I(n) by using the encoding-information frame indices A as frame indices for encoded frames including beginning portions of main data therein, or frame indices for encoded frames including beginning portions of the main data needed for decoding the corresponding frames.

### Sixth Embodiment

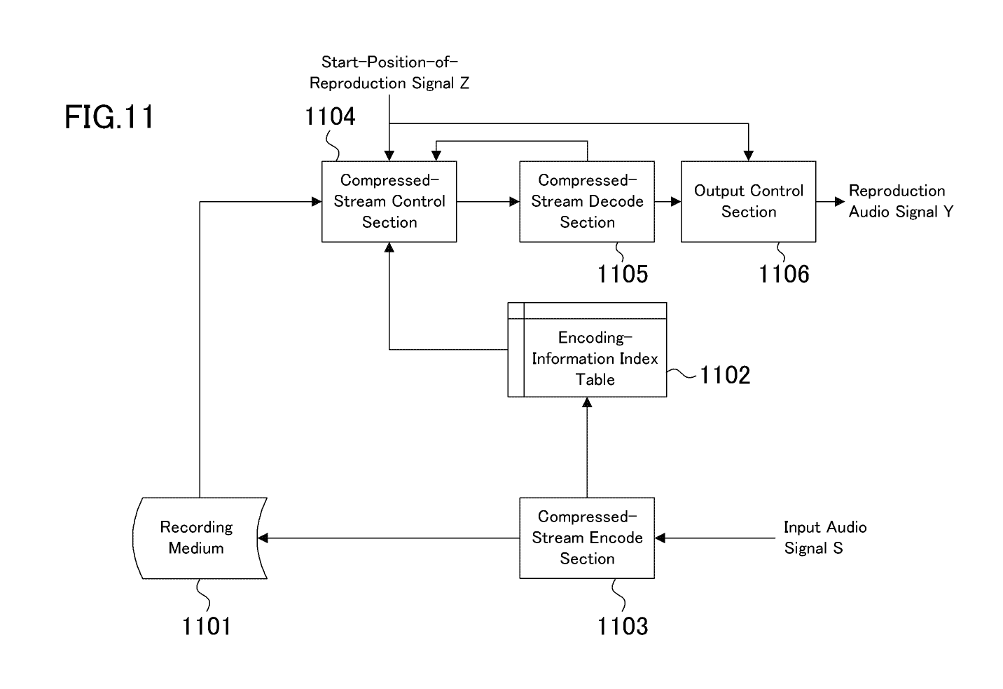

FIG. 11 is a block diagram illustrating a configuration of an audio recording/playback device according to the sixth embodiment. In FIG. 11, a component 1101 is a recording medium capable of storing a compressed stream generated by organizing a time series of digital audio signals into units of encoded frames. A component 1102 is an encoding-information index table which holds indices for frames into which encoding information is multiplexed. A component 1103 is a compressed-stream encode section which encodes the input audio signals into a compressed stream. A component 1104 is a compressed-stream control section which reads the compressed audio stream from the recording medium 1101, and upon receiving a playback restart instruction, determines a start position of reading the compressed stream from the recording medium 1101, and determines a start position of the output. A component 1105 is a compressed-stream decode section which can decode the compressed audio stream read by the compressed-stream control section 1104 into the digital audio signals, and can transmit the obtained decoding information to the compressed-stream control section 1104. A component 1106 is an output control section which controls whether or not to output the playback digital audio signals decoded by the compressed-stream decode section 1105 as sound according to an instruction of a start-position-of-playback signal Z.

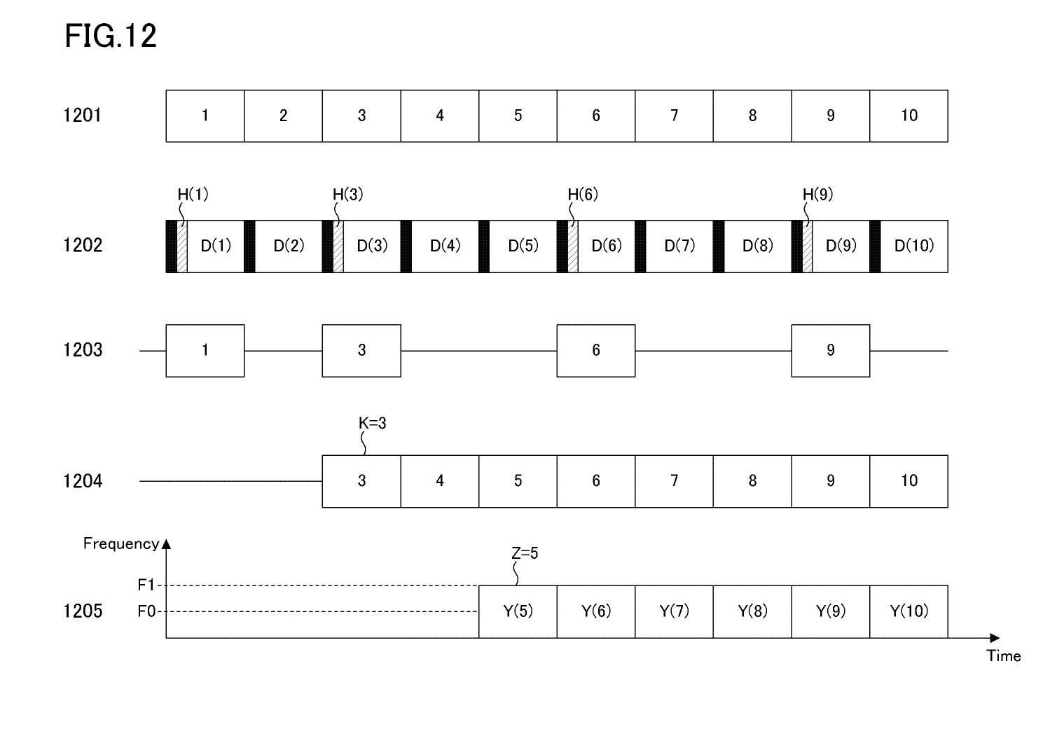

The basic operation of this audio recording/playback device will be described below using FIG. 12.

FIG. 12 is a diagram for illustrating a case where a compressed audio stream X recorded by this audio recording/playback device is played back. In FIG. 12, a row 1201 shows frame numbers of encoded frames of the compressed audio stream X. A row 1202 shows the compressed stream X encoded by the compressed-stream encode section 1103. A row 1203 shows the frame numbers of frames into which encoding information H is multiplexed by the compressed-stream encode section 1103. A row 1204 shows the frame numbers of the compressed stream transmitted to the compressed-stream decode section 1105 upon playback. A row 1205 shows the playback digital audio signals Y output from the compressed-stream decode section 1105 at each encoded frame and then output by the output control section 1106. The vertical axis and the horizontal axis of the row 1205 respectively indicate the frequency and the time.

As shown in FIG. 12, the compressed audio stream X includes encoded data D(m) [m=1, 2, 3, . . . ] and encoding information H(n) [n=1, 2, 3, . . . ].

When recording a compressed stream, the compressed-stream encode section 1103 encodes input audio signals S to a compressed stream, stores the compressed stream on the recording medium 1101, and records the frame indices for frames into which encoding information is multiplexed to the encoding-information index table 1102.

When playing back the compressed stream, the compressed-stream control section 1104 obtains the frame index K (K=3) immediately before the start position of playback Z from the frame indices recorded in the encoding-information index table 1102, and transmits the compressed stream X to the compressed-stream decode section 1105 starting at the position of the frame index K. The compressed-stream decode section 1105 decodes the compressed stream X, and transmits the decoded playback audio signals Y and the decoded frame indices N together to the output control section 1106. The output control section 1106 determines whether or not a frame index N for a playback audio signal Y matches the restart position of playback Z (Z=5), and outputs the playback audio signals Y(n) [n=5, 6, 7, . . . ] at and after the matched frame.

Thus, when playing back a compressed stream recorded by the audio recording/playback device, the playback audio signals Y(2), Y(4), Y(5), Y(7), and Y(8) can be output with a waveform having a right frequency range extended to a frequency range F1 even when playback is started at encoded data D(m) [m=2, 4, 5, 7, and 8] into which encoding information H is not multiplexed.

### Seventh Embodiment

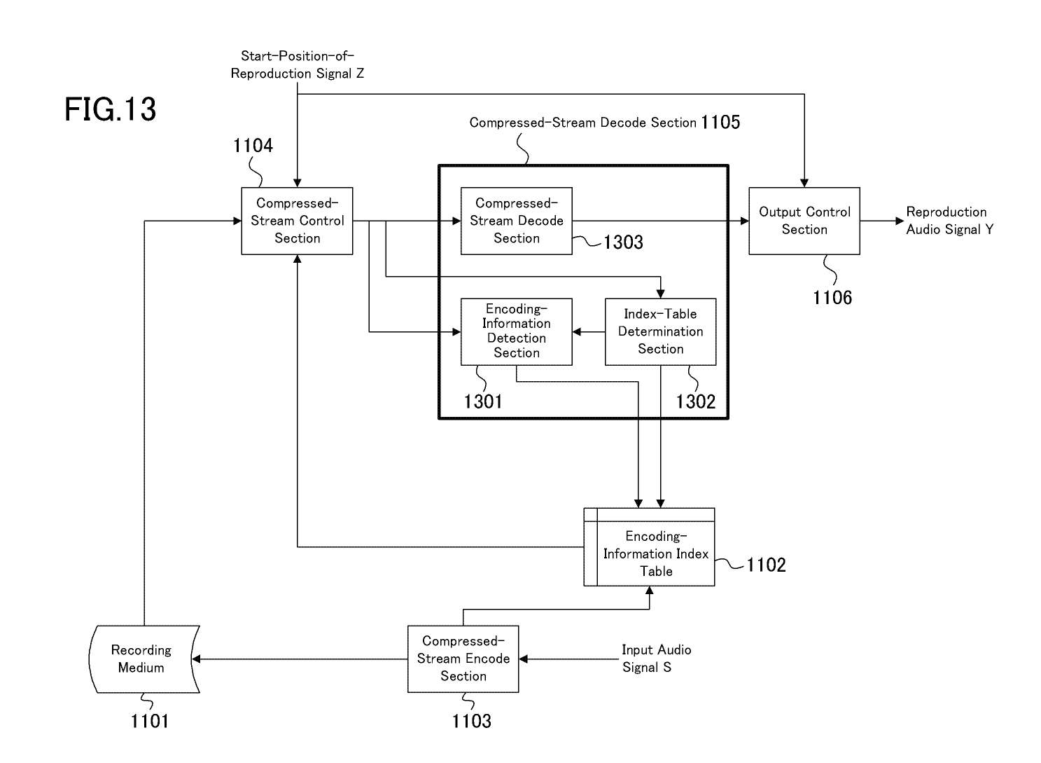

FIG. 13 is a diagram illustrating a configuration of an audio recording/playback device according to the seventh embodiment. In FIG. 13, a component 1301 is an encoding-information detection section which detects asynchronously-multiplexed encoding information in a compressed stream, and writes a frame position thereof to the encoding-information index tables 1102. A component 1302 is an index-table determination section which determines whether or not index information for the compressed stream to be decoded exists in the encoding-information index tables 1102. A component 1303 is a compressed-stream decode section which decodes the compressed stream.

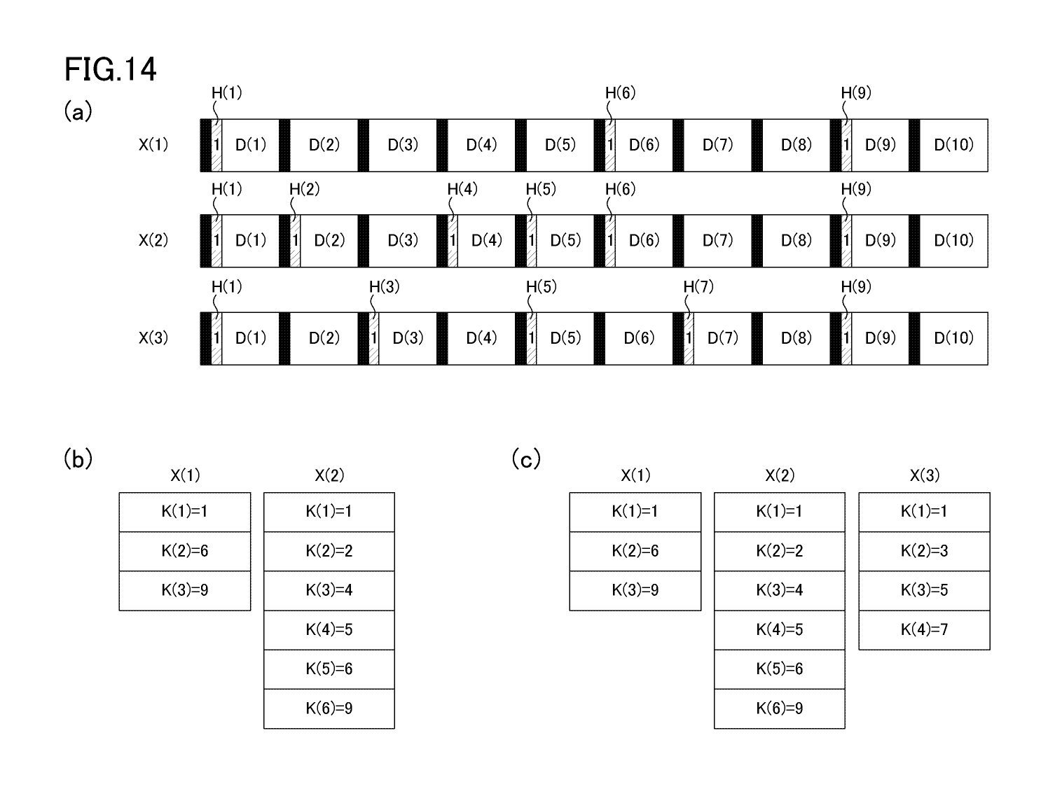

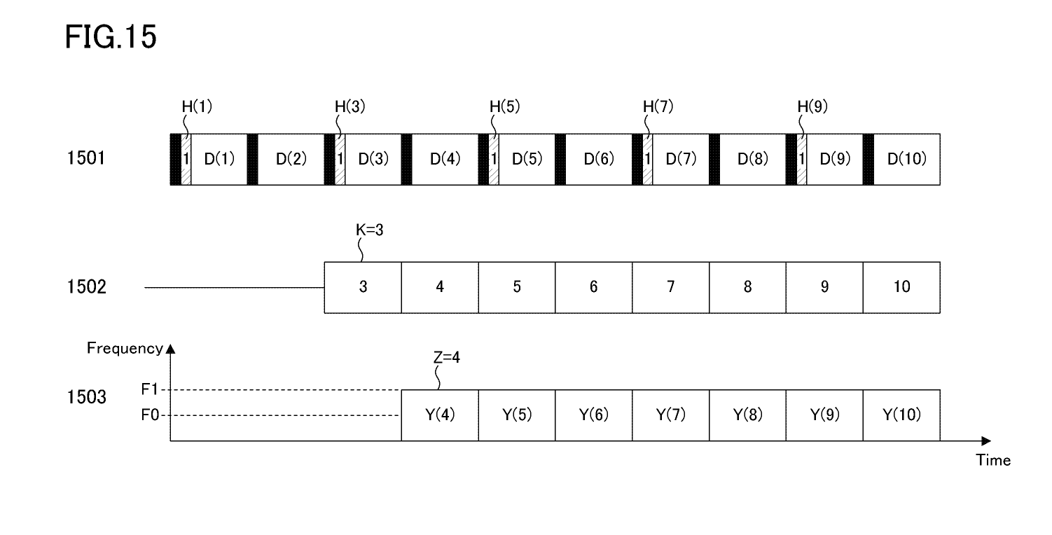

The operation of the audio recording/playback device according to this embodiment will be described below using FIGS. 14 and 15.

FIGS. 14A-14C illustrate the correspondence between compressed audio X(n) [n=1, 2, and 3] and the contents of the encoding-information index tables 1102. FIG. 14A illustrates the contents of the compressed audio X(n) [n=1, 2, and 3]. FIG. 14B illustrates the contents of the encoding-information index tables 1102 before the compressed audio X(3) is played back. FIG. 14C illustrates the contents of the encoding-information index tables 1102 after the compressed audio X(3) is played back.

FIG. 15 is a diagram for illustrating a second playback or later of the compressed audio X(3). In FIG. 15, a row 1501 shows the compressed audio X(3). A row 1502 shows the frame numbers of the compressed stream transmitted to the compressed-stream decode section 1105 upon playback. A row 1503 shows the playback digital audio signals Y output from the compressed-stream decode section 1303 at each encoded frame and then output by the output control section 1106. The vertical axis and the horizontal axis of the row 1503 respectively indicate the frequency and the time.

When the compressed stream X(3) is played back for the first time, the compressed-stream control section 1104 transmits the compressed stream X(3) to the compressed-stream decode section 1303, to the index-table determination section 1302, and to the encoding-information detection section 1301. The index-table determination section 1302 determines whether or not the index table corresponding to the transmitted compressed stream X(3) exists in the encoding-information index tables 1102, and provides the determination result for the encoding-information detection section 1301. Since any index table corresponding to the compressed stream X(3) does not exists, the encoding-information detection section 1301 performs detection of encoding information from the compressed stream X(3), and generates an index table corresponding to the compressed stream X(3) in the encoding-information index tables 1102 based on the detected positions of encoded information as shown in FIG. 14C.

When the compressed stream X(3) is played back for the second time or later, the compressed-stream control section 1104 obtains the frame index K (K=3) immediately before the start position of playback Z (Z=4) from the index table corresponding to the compressed stream X(3) recorded in the encoding-information index tables 1102, and transmits the compressed stream X to the compressed-stream decode section 1105 starting from a frame having the obtained frame index K (K=3) as shown in the row 1502. The compressed-stream decode section 1105 decodes the compressed stream X by the compressed-stream decode section 1303, and transmits the decoded playback audio signals Y and the decoded frame indices N together to the output control section 1106. The output control section 1106 determines whether or not a frame index N for a playback audio signal Y matches the restart position of playback Z (Z=4), and outputs the playback audio signals Y(n) [n=4, 5, 6, 7, . . . ] at and after the matched frame as shown in the row 1503.

Thus, when playing back a compressed stream recorded by a device other than this audio recording/playback device, an encoding-information index table is generated upon a first playback, and upon or after the second playback, the playback audio signals can be output with a waveform having a right frequency range extended to a frequency range F1 even when playback is started at a frame into which encoding information H is not multiplexed.

### Eighth Embodiment

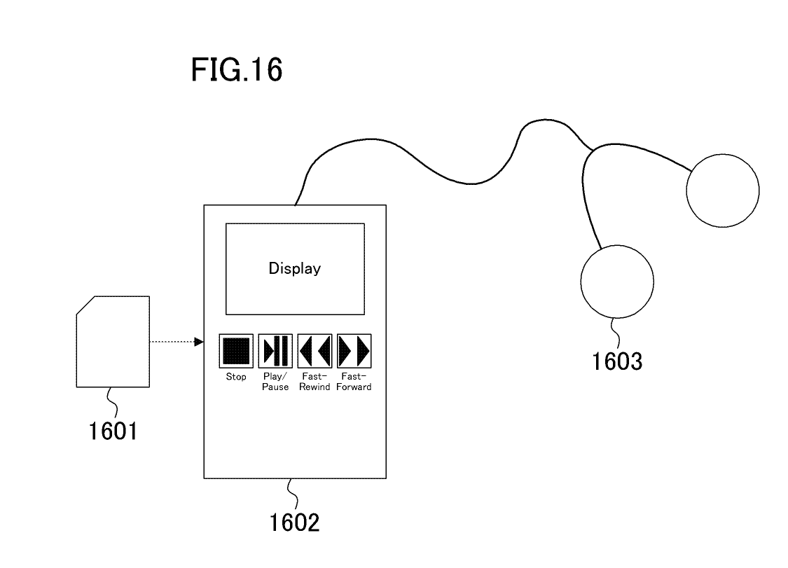

FIG. 16 illustrates an example of an audio playback apparatus according to the eighth embodiment. In FIG. 16, a component 1601 is a recording medium capable of recording compressed audio content. While drawn as a medium removable from the apparatus in the figure, the recording medium may be implemented by a flash memory removable from the apparatus such as an SD card, or an optical disk, or may be implemented by a HDD integrated into the apparatus etc. A component 1602 is a compressed audio playback apparatus, and is configured such that the components in the apparatus include at least one of the audio playback devices described for the first to the seventh embodiments described above. A component 1603 is a speaker device such as a headphone set. Using such a configuration for an audio playback apparatus, output audio signals extended to a right frequency range can be promptly obtained without any section not played back even when playback is restarted after an interruption.

### Ninth Embodiment

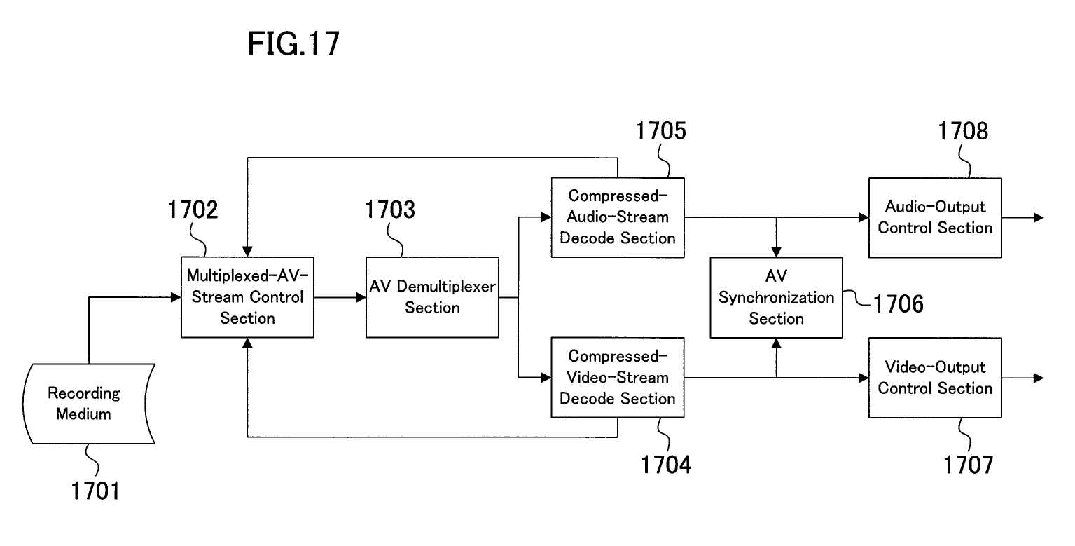

FIG. 17 is a block diagram illustrating a configuration of an AV-stream playback device according to the ninth embodiment.

In FIG. 17, a component 1701 is a recording medium capable of storing a multiplexed AV stream constructed by multiplexing both a compressed audio stream generated by organizing a time series of digital audio signals into units of encoded frames, and a compressed video stream generated by organizing a time series of digital video signals into units of pictures.

A component 1702 is a multiplexed-AV-stream control section which holds information on a start position of reading the multiplexed AV stream and audio frame information before an interruption of playback, and compressed-video-stream resume information; and when playback is restarted after the interruption, calculates a start position of reading the multiplexed AV stream from the recording medium 1701 based on additional resume information for determining whether or not a decoded audio frame has information asynchronously multiplexed thereinto, on the audio frame information, and on the compressed-video-stream resume information.

A component 1703 is an AV demultiplexer section which demultiplexes the multiplexed AV stream read by the multiplexed-AV-stream control section 1702 into a compressed audio stream and a compressed video stream.

A component 1704 is a compressed-video-stream decode section which decodes the compressed video stream to digital video signals, generates the compressed-video-stream resume information from obtained decoding information, and transmits the compressed-video-stream resume information to the multiplexed-AV-stream control section 1702.

A component 1705 is a compressed-audio-stream decode section which decodes the compressed audio stream to digital audio signals, generates the additional resume information based on obtained decoding information, and transmits the additional resume information to the multiplexed-AV-stream control section 1702.

A component 1706 is an AV synchronization section which time-synchronizes respective decoding results output from the compressed-video-stream decode section 1704 and the compressed-audio-stream decode section 1705.

A component 1707 is a video-output control section which determines whether output should be performed or not according to the decoding result of the compressed video stream, and performs an output accordingly.

A component 1708 is an audio-output control section which outputs the audio along with mute control and fade control according to the decoding result of the compressed audio stream.

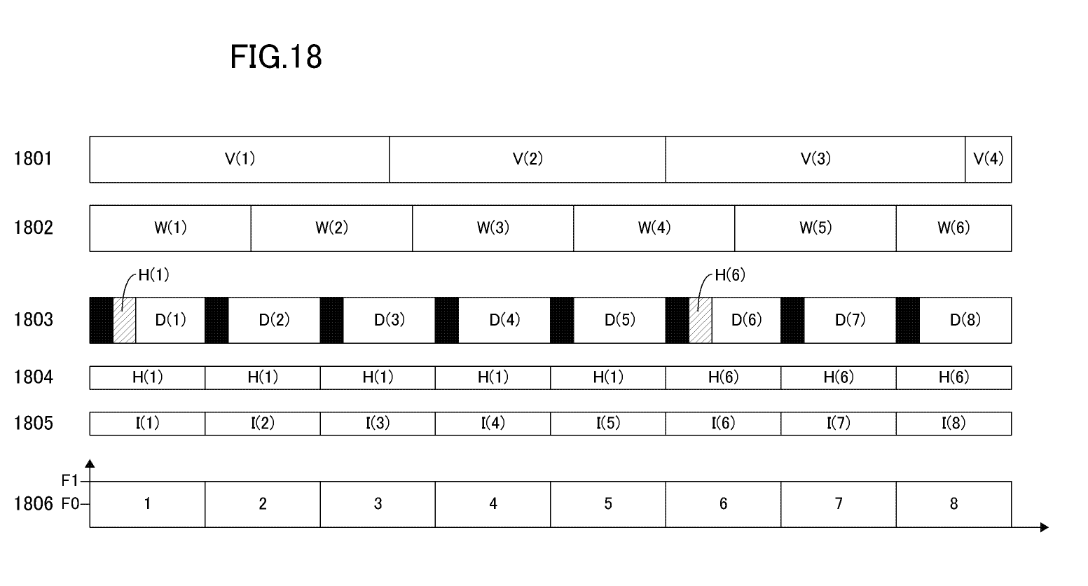

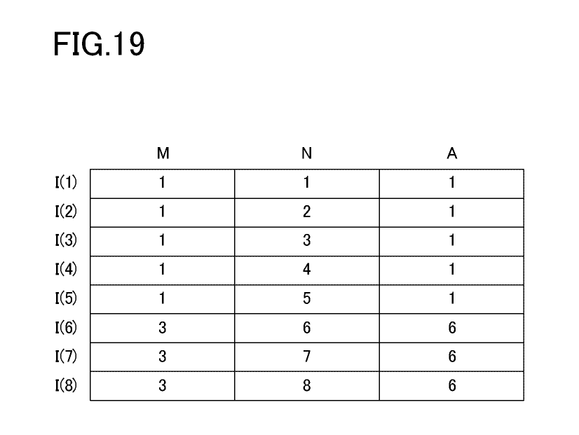

The basic operation of this AV-stream playback device will be described below using FIGS. 18 and 19.

FIG. 18 illustrates a relationship over time between a multiplexed AV stream V input to this AV-stream playback device, compressed video and audio streams W and X to be demultiplexed from the multiplexed AV stream V, and encoding information H needed for decoding the compressed audio stream X to digital audio signals Y.

In FIG. 18, a row 1801 shows packets of a multiplexed AV stream V. A row 1802 shows a compressed video stream W obtained by demultiplexing the multiplexed AV stream V. A row 1803 shows a compressed audio stream X obtained by demultiplexing the multiplexed AV stream V. A row 1804 shows encoding information H utilized for each encoded frame. A row 1805 shows the additional resume information I(n) [n=1, 2, 3, . . . ] generated by the compressed-audio-stream decode section 1705 for each encoded frame. A row 1806 shows the playback digital audio signals Y output from the compressed-audio-stream decode section 1705 at each encoded frame. The vertical axis and the horizontal axis of the row 1806 respectively indicate the frequency and the time.

As shown in FIG. 18, the compressed audio stream X includes encoded data D(m) └m=1, 2, 3, . . . ┘ and encoding information H(n) └n=1, 2, 3, . . . ┘.

The multiplexed-AV-stream control section 1702 reads packets of a multiplexed AV stream including encoded data D of a frame number specified by a frame index N from the recording medium 1701, and outputs the corresponding encoded data of the compressed audio stream demultiplexed by the AV demultiplexer section 1703 to the compressed-audio-stream decode section 1705. For example, if the audio frame index N specifies a frame number “1,” then the multiplexed-AV-stream control section 1702 reads the multiplexed AV packet V(1) including the encoded data corresponding to the audio frame number “1,” and outputs the encoded data D(1), demultiplexed in the AV demultiplexer section 1703, to the compressed-audio-stream decode section 1705.

The compressed-audio-stream decode section 1705 extracts the encoding information H upon decoding the compressed audio stream X. Then, the compressed-audio-stream decode section 1705 generates and transmits the additional resume information I(n) which associates the encoding information H with the frame indices N for the encoded frames, to the multiplexed-AV-stream control section 1702.

FIG. 19 shows an example configuration in which the additional resume information I(n) of a compressed audio stream includes encoding-information frame indices A for the compressed audio stream associated with the encoding information H, the frame indices N for the encoded frames which have been decoded, and packet indices M for the multiplexed AV stream into which the encoded frames corresponding to the encoding-information frame indices A are multiplexed. The multiplexed-AV-stream control section 1702 holds the additional resume information I(n) at the time of receiving a playback interrupt instruction, of the additional resume information transmitted at every frame; and upon receiving a playback restart instruction, the multiplexed-AV-stream control section 1702 reads information from the additional resume information I(n), determines a start position of reading the multiplexed AV stream based on a packet index for the multiplexed AV stream stored as the resume position of audio and on compressed-video-stream resume information so that both audio and video resume playback is properly performed, inputs the read multiplexed AV stream to the AV demultiplexer section 1703, and then transmits frames to the compressed-audio-stream decode section 1705, starting with a frame matching an encoding-information frame index A. This allows the playback audio signals Y(2)-Y(5) to be output with a waveform having a right frequency range extended to a frequency range F1 even when playback is restarted at encoded data D(m) [m=2, 3, 4, and 5] into which encoding information H is not multiplexed.

### Tenth Embodiment

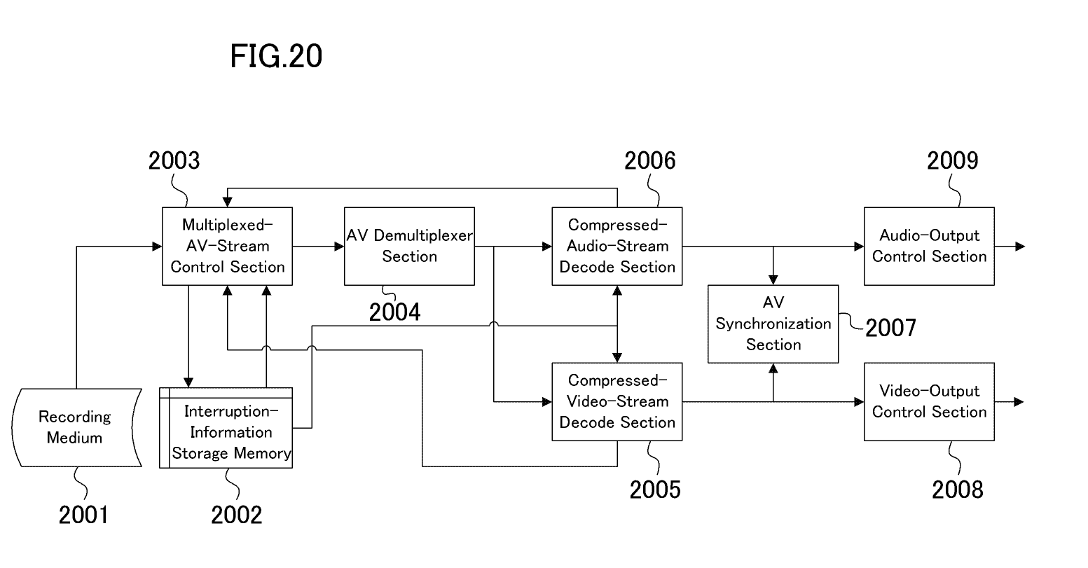

FIG. 20 is a block diagram illustrating a configuration of an AV-stream playback device according to the tenth embodiment.

In FIG. 20, a component 2001 is a recording medium capable of storing a multiplexed AV stream constructed by multiplexing both a compressed audio stream generated by organizing a time series of digital audio signals into units of encoded frames, and a compressed video stream generated by organizing a time series of digital video signals into units of pictures.

A component 2002 is an interruption-information storage memory for storing as resume information a position to restart when a playback instruction is next received, when playback is interrupted. It is preferable that the interruption-information storage memory 2002 be formed of a non-volatile memory so that no information is lost upon a power-off operation etc.

A component 2003 is a multiplexed-AV-stream control section which reads the multiplexed AV stream from the recording medium 2001, stores resume information including multiplexed-AV packet information, audio packet information, and video packet information at the time of interruption to the interruption-information storage memory 2002 when a playback interrupt instruction is received; and when a playback restart instruction is received, reads the resume information from the interruption-information storage memory 2002, determines a start position of reading the multiplexed AV stream from the recording medium 2001, and determines a start position of the output.

A component 2004 is an AV demultiplexer section which demultiplexes the multiplexed AV stream read by the multiplexed-AV-stream control section 2003 into a compressed audio stream and a compressed video stream.

A component 2005 is a compressed-video-stream decode section which decodes the compressed video stream to digital video signals, generates the compressed-video-stream resume information from obtained decoding information, and transmits the compressed-video-stream resume information to the multiplexed-AV-stream control section 2003.

A component 2006 is a compressed-audio-stream decode section capable of decoding the compressed audio stream to digital audio signals, and transmitting the obtained decoding information to the multiplexed-AV-stream control section 2003.

A component 2007 is an AV synchronization section which time-synchronizes respective decoding results output from the compressed-video-stream decode section 2005 and the compressed-audio-stream decode section 2006.

A component 2008 is a video-output control section which determines whether output should be performed or not according to the decoding result of the compressed video stream, and performs an output accordingly.

A component 2009 is an audio-output control section which outputs the audio along with mute control and fade control according to the decoding result of the compressed audio stream.

The basic operation of this AV-stream playback device will be described below using FIGS. 18 and 19.

FIG. 18 illustrates a relationship over time between a multiplexed AV stream V input to this AV-stream playback device, compressed video and audio streams W and X to be demultiplexed from the multiplexed AV stream V, and encoding information H needed for decoding the compressed audio stream X to digital audio signals Y.

In FIG. 18, a row 1801 shows packets of a multiplexed AV stream V. A row 1802 shows a compressed video stream W obtained by demultiplexing the multiplexed AV stream V. A row 1803 shows a compressed audio stream X obtained by demultiplexing the multiplexed AV stream V. A row 1804 shows encoding information H utilized for each encoded frame. A row 1805 shows the additional resume information I(n) [n=1, 2, 3, . . . ] generated by the compressed-audio-stream decode section 2006 for each encoded frame. A row 1806 shows the playback digital audio signals Y output from the compressed-audio-stream decode section 2006 at each encoded frame. The vertical axis and the horizontal axis of the row 1806 respectively indicate the frequency and the time.

As shown in FIG. 18, the compressed audio stream X includes encoded data D(m) [m=1, 2, 3, . . . ] and encoding information H(n) [n=1, 2, 3, . . . ].

The multiplexed-AV-stream control section 2003 outputs encoded data D of a frame number specified by a frame index N to the compressed-audio-stream decode section 2006. For example, if the frame index N specifies a frame number “1,” then the multiplexed-AV-stream control section 2003 outputs the encoded data D(1) corresponding to the frame number “1” to the compressed-audio-stream decode section 2006.

The compressed-audio-stream decode section 2006 extracts the encoding information H upon decoding the compressed audio stream X. Then, the compressed-audio-stream decode section 2006 generates and transmits the additional resume information I(n) which associates the encoding information H with the frame indices N for the encoded frames, to the multiplexed-AV-stream control section 2003.

FIG. 19 shows an example configuration in which the additional resume information I(n) of a compressed audio stream includes encoding-information frame indices A for the compressed audio stream associated with the encoding information H, the frame indices N for the encoded frames which have been decoded, and packet indices M for the multiplexed AV stream into which the encoded frames corresponding to the encoding-information frame indices A are multiplexed.

The multiplexed-AV-stream control section 2003 writes the additional resume information I(n) transmitted at every frame to the interruption-information storage memory 2002, and when a playback interrupt instruction is received, the multiplexed-AV-stream control section 2003 writes the frame index N of the encoded frame at the time of receiving the interrupt instruction and compressed-video-stream resume information. The interruption-information storage memory 2002 stores the packet index M as a start position of reading the multiplexed AV stream for decoding the compressed audio stream, the encoding-information frame index A for the compressed audio stream as a start position for decoding the compressed audio stream, and the frame index N as a position of audio start-of-output frame.

Then, when a playback restart instruction is received, the multiplexed-AV-stream control section 2003 reads information from the interruption-information storage memory 2002, and compares resume information of the compressed video stream and resume information of the compressed audio stream; if the packet index M included in the resume information of the compressed audio stream indicates an earlier position than that indicated by the packet index of the resume information of the compressed video stream, then the multiplexed AV stream is read from the recording medium 2001 starting with a packet indicated by the packet index M stored as the start position of reading the multiplexed AV stream for decoding the compressed audio stream, and is transmitted to the AV demultiplexer section 2004; the compressed audio stream demultiplexed in the AV demultiplexer section 2004 from the multiplexed AV stream is transmitted to the compressed-audio-stream decode section 2006, starting with a frame matching the encoding-information frame index A; and the compressed video stream demultiplexed in the AV demultiplexer section 2004 from the multiplexed AV stream is transmitted to the compressed-video-stream decode section 2005, starting at a resume position indicated by the resume information for the compressed video stream. This allows the playback audio signals Y(2)-Y(5) to be output with a waveform having a right frequency range extended to a frequency range F1 and the video to be restarted at a right position, even when the encoded frame indicated as the resume position of the compressed audio stream is encoded data D(m) [m=2, 3, 4, and 5] into which encoding information H is not multiplexed.

Similarly, if the packet index of the resume information of the compressed video stream indicates an earlier position than that indicated by the packet index M included in the resume information of the compressed audio stream, then the multiplexed AV stream is read from the recording medium 2001 starting at the resume position of the compressed video stream, and data transmitted to the compressed-audio-stream decode section 2006 and to the compressed-video-stream decode section 2005 are adjusted in the AV demultiplexer section 2004, thereby allowing a proper restart of playback.

### Eleventh Embodiment

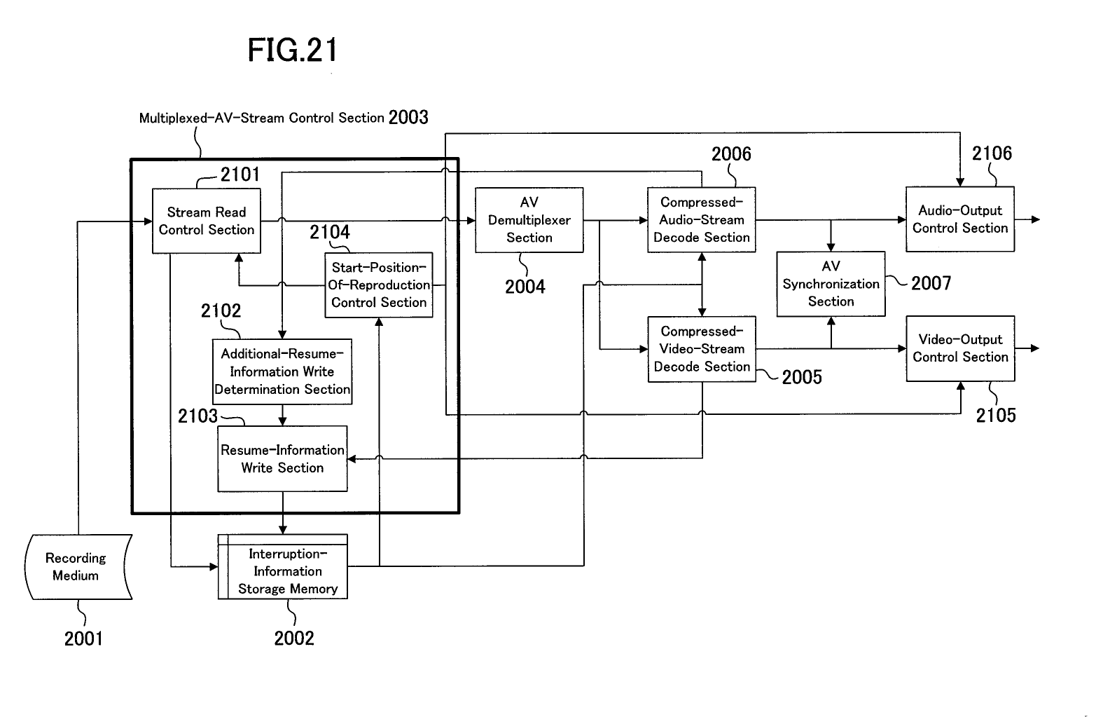

FIG. 21 is a block diagram illustrating a configuration of an AV-stream playback device according to the eleventh embodiment.

A component 2105 is a video-output control section, which is a modification of the video-output control section 2008 of FIG. 20, capable of controlling whether or not to output the playback digital video signals decoded by the compressed-video-stream decode section 2005 to a display device according to an instruction of a start-position-of-playback control section 2104. A component 2106 is an audio-output control section, which is a modification of the audio-output control section 2009 of FIG. 20, capable of controlling whether or not to output the playback digital audio signals decoded by the compressed-audio-stream decode section 2006 as sound according to an instruction of the start-position-of-playback control section 2104.

The multiplexed-AV-stream control section 2003 includes a stream read control section 2101, an additional-resume-information write determination section 2102, a resume-information write section 2103, and the start-position-of-playback control section 2104.

The stream read control section 2101 reads and transmits a multiplexed AV stream from the recording medium 2001 to the AV demultiplexer section 2004.

The additional-resume-information write determination section 2102 analyzes additional resume information I(n) generated by the compressed-audio-stream decode section 2006, and determines to write the additional resume information I(n) to the interruption-information storage memory 2002 only if the encoding-information frame index A matches the frame index N.

The resume-information write section 2103 writes both the output of the additional-resume-information write determination section 2102 and the video resume information generated by the compressed-video-stream decode section 2005 to the interruption-information storage memory 2002.

The start-position-of-playback control section 2104 reads the resume information from the interruption-information storage memory 2002, instructs the stream read control section 2101 to read frames starting with a frame indicated by the encoding-information frame index A, and instructs the audio-output control section 2106 to start outputting frames starting with a frame indicated by a frame index N.

The operation with respect to the playback of digital audio signals by the AV-stream playback device according to this embodiment is similar to that shown in FIGS. 6 and 7 used for the third embodiment.

In FIG. 6, a row 601 shows frame numbers of encoded frames of the compressed audio stream X. A row 602 shows the compressed audio stream X of each encoded frame. A row 603 shows the encoding information H utilized for each encoded frame of the compressed audio stream X. A row 604 shows the additional resume information I(n) generated by the compressed-audio-stream decode section 2006 for each encoded frame of the compressed audio stream X. A row 605 shows the timings when the additional resume information I(n) is written into the interruption-information storage memory 2002 by the resume-information write section 2103 after write permission is granted by the additional-resume-information write determination section 2102. A row 606 shows the playback digital audio signals Y output from the compressed-audio-stream decode section 2006 at each encoded frame of the compressed audio stream X. The vertical axis and the horizontal axis of the row 606 respectively indicate the frequency and the time.

As shown in FIG. 6, while the additional resume information I(n) is generated by the compressed-audio-stream decode section 2006 for each encoded frame, the write operation to the interruption-information storage memory 2002 is performed only if a frame into which the encoding information H is multiplexed has been decoded, thereby reducing the bus load with respect to the interruption-information storage memory 2002.

FIG. 7 shows an example in which playback is restarted at encoded data D(3) into which encoding information H is not multiplexed. In FIG. 7, a row 701 shows frame numbers of encoded frames of the compressed audio stream X. A row 702 shows the compressed audio stream X of each encoded frame. A row 703 shows the timings when the additional resume information I(n) is written into the interruption-information storage memory 2002. A row 704 shows decoded signals Y transmitted from the compressed-audio-stream decode section 2006 to the audio-output control section 2106 at each encoded frame. A row 705 shows the playback digital audio signals Z output from the audio-output control section 2106 to the outside. The vertical axes and the horizontal axes of the rows 704 and 705 respectively indicate the frequency and the time.

As shown in FIG. 7, encoded data are transmitted to the compressed-audio-stream decode section 2006 starting with the encoded data D(1) corresponding to a frame index indicated in the additional resume information I(n) read from the interruption-information storage memory 2002, thus the decoded signal corresponding to the encoded data D(1) is transmitted to the audio-output control section 2106; however, the start-position-of-playback control section 2104 instructs the audio-output control section 2106 to output decoded signals starting from the decoded signal Y(3) as a playback audio signal, thereby allowing the playback digital audio signals Z to be output starting at a right restart position Z(3) without outputting unnecessary decoded signals Y(1) and Y(2), with a waveform having a right frequency range extended to a frequency range F1.

### Twelfth Embodiment

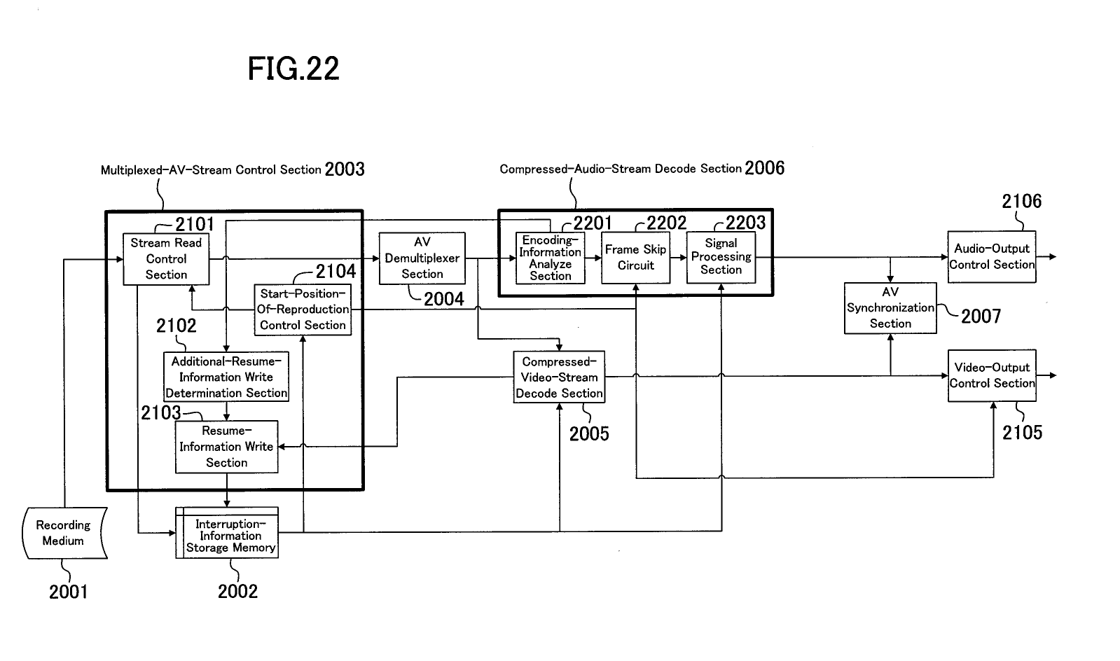

FIG. 22 is a block diagram illustrating a configuration of an AV-stream playback device according to the twelfth embodiment. In FIG. 22, a component 2204 is a start-position-of-playback control section, which is provided instead of the start-position-of-playback control section 2104 of FIG. 21, capable of notifying the compressed-audio-stream decode section 2006 of a playback-start frame.

The compressed-audio-stream decode section 2006 includes an encoding-information analyze section 2201, a frame skip circuit 2202, and a signal processing section 2203. The encoding-information analyze section 2201 analyzes the compressed audio stream, extracts and stores encoding information in advance, and generates additional resume information I(n). The frame skip circuit 2202 determines whether each frame is an unnecessary frame or not based on both an instruction from the start-position-of-playback control section 2204 and the encoding information extracted in the encoding-information analyze section 2201; and if unnecessary, the frame skip circuit 2202 controls so that the encoded data are not supplied to the signal processing section 2203. The signal processing section 2203 performs signal processing on and decoding of the encoded data.

The operation with respect to the playback of digital audio signals by the AV-stream playback device according to this embodiment is similar to that shown in FIG. 9 used for the fourth embodiment, thus the operation thereof will be described below using FIG. 9.

FIG. 9 illustrates an operation over time in which playback is restarted at encoded data D(3). In FIG. 9, a row 901 shows frame numbers of encoded frames of the compressed audio stream X. A row 902 shows the compressed audio stream X of each encoded frame transmitted to the compressed-audio-stream decode section 2006 after playback is restarted. A row 904 shows the additional resume information I(n) generated by the encoding-information analyze section 2201 for each encoded frame. A row 906 shows the playback digital audio signals Y decoded by the signal processing section 2203 after the frame skip circuit 2202 determines whether each frame is an unnecessary frame or not. The vertical axis and the horizontal axis of the row 906 respectively indicate the frequency and the time.

As shown in FIG. 9, although encoded data are sequentially transmitted to the compressed-audio-stream decode section 2006 starting with the encoded data D(1) corresponding to a frame index indicated in the additional resume information I(n), the encoded data D(1) and D(2) are skipped by the frame skip circuit 2202 as unnecessary frames; thus, encoded data are transmitted to the signal processing section 2203 starting with the encoded data D(3), which is a playback-restart frame, thereby allowing the playback audio signals Y to be output starting at a right restart position Z(3), without decoding the unnecessary frames D(1) and D(2), with a waveform having a right frequency range extended to a frequency range F1, and also allows the processing load of signal processing to be reduced.

### Thirteenth Embodiment

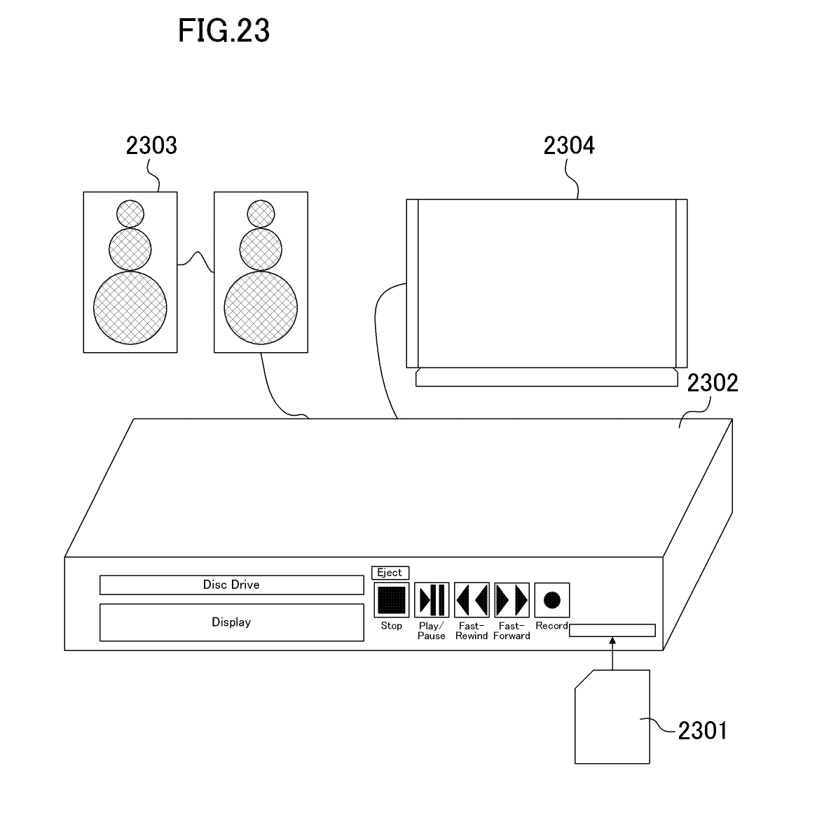

FIG. 23 illustrates an example of an AV-stream playback apparatus according to the thirteenth embodiment. In FIG. 23, a component 2301 is a recording medium capable of recording multiplexed AV content. While drawn as a medium removable from the apparatus in the figure, the recording medium may be implemented by a flash memory removable from the apparatus such as an SD card, or an optical disk, or may be implemented by a HDD integrated into the apparatus, etc. A component 2302 is an AV-stream playback apparatus, and is configured such that the components in the apparatus include at least one of the AV-stream playback devices described for the ninth to the twelfth embodiments. A component 2303 is a speaker device which plays back the audio signals output from the AV-stream playback apparatus 2302 as sound. A component 2304 is a display device which outputs video signals output from the AV-stream playback apparatus 2302 as video. Using such a configuration for an AV-stream playback apparatus, output audio signals extended to a right frequency range can be promptly obtained without any section not played back, not only for video, but also for sound, even when playback is restarted after an interruption.

The processing in each component block of the audio and the AV-stream playback apparatuses in the description of each embodiment described above can also be implemented in software programs on a computer or on a digital signal processor (DSP).

In addition, although in the description above, encoding information is formed of common band-spreading data distributed into a part of encoded frames, of encoded audio signals generated using a band spread technology such as AAC+SBR as an example of a compressed audio stream, similar principles and teachings can also be applied to a case where encoding information includes encoding parameters used for decoding core encoded data distributed and multiplexed into a part of encoded frames, of encoded audio signals generated only using core encoding process such as in MP3.

The present invention can be used for an audio playback device having a function to restart playback from an interrupted position after an interruption of playback due to a power-off operation etc., and an audio playback device having special playback functions including fast-forwarding playback in which only a limited number of encoded frames are played back, both capable of decoding based on asynchronously-multiplexed encoding information, even when decoding an encoded frame into which no encoding information is multiplexed in a case where a decoding process is performed from an encoded frame in the middle of a time series of successive encoded frames, or in a case where a decoding process is performed for a limited set of encoded frames for fast-forwarding.

What is claimed is:

1. An audio playback device capable of playing back a compressed audio stream constructed by multiplexing encoding information asynchronously with respect to encoded frames into a compressed stream generated by organizing a time series of digital audio signals into units of encoded frames, characterized in that:
when playback is restarted after an interruption, playback is restarted with a waveform extended to a right frequency range without any section not played back in terms of time, based on information on the compressed audio stream recorded before the interruption.

2. The audio playback device of claim 1, comprising:
a recording medium on which a compressed audio stream is recorded;
a compressed-stream control means configured to hold frame information on the compressed audio stream before the interruption of playback, and configured to, when playback is restarted after the interruption, calculate a start position of reading the compressed stream from the recording medium based on additional resume information for determining whether or not a decoded audio frame has encoding information asynchronously multiplexed thereinto, and on the audio frame information;
a compressed-stream decode means configured to decode the compressed audio stream read by the compressed-stream control means, to generate the additional resume information based on decoding information obtained by decoding the frames, and to transmit the additional resume information to the compressed-stream control means; and
an output control means configured to determine whether a decoding result of the compressed audio stream should be output or not, and to perform an output accordingly.

3. The audio playback device of claim 1, comprising:
a recording medium on which a compressed audio stream is recorded;
a compressed-stream control means configured to hold frame information on the compressed audio stream at the time of an interruption of playback, to calculate a start position of reading the compressed audio stream from the recording medium, and to read the compressed audio stream;
a compressed-stream decode means configured to decode the compressed audio stream read by the compressed-stream control means, to generate additional resume information so as to include information at least enabling a determination whether a frame into which encoding information is asynchronously multiplexed has been decoded or not, of the decoding information obtained by decoding the frame, and to transmit the additional resume information to the compressed-stream control means;
an output control means configured to determine whether a decoding result of the compressed audio stream should be output or not, and to perform an output accordingly; and
an interruption-information storage memory configured to store resume information needed to restart playback upon the interruption of playback of the compressed audio stream, wherein
when playback is restarted after the interruption, playback can be restarted without any section not played back in terms of time and without any frequency range not played back, by calculating a start position of reading the compressed audio stream based on both the additional resume information transmitted from the compressed-stream decode means and the frame information at the time of the interruption, and by reading the compressed audio stream from the recording medium.

4. The audio playback device of claim 2 or 3, wherein
the compressed-stream control means includes
a compressed-stream read control means configured to read the compressed audio stream from the recording medium upon receiving a playback start instruction or a playback restart instruction, and to write information on the stream being played back to the interruption-information storage memory upon receiving a playback interrupt instruction,
a start-position-of-playback control means configured to, if interruption information is stored in the interruption-information storage memory, instruct the compressed-stream read control means on a start position of reading the compressed audio stream from the recording medium, and
an additional-resume-information write determination means configured to write as appropriate the additional resume information to the interruption-information storage memory if the additional resume information transmitted from the compressed-stream decode means to the interruption-information storage memory includes information enabling a determination whether a frame into which encoding information is asynchronously multiplexed has been decoded or not, and
a determination of the start position of reading by the start-position-of-playback control means and a determination of an output-start frame by the output control means are made upon a restart of playback based on the resume information and the additional resume information.

5. The audio playback device of claim 2 or 3, wherein
the compressed-stream decode means includes
an encoding-information analyze section configured to analyze encoded frames in the compressed audio stream, to extract asynchronously-multiplexed encoding information, to generate the additional resume information by combining either or both of the extracted encoding information or auxiliary decoding information obtained by the encoding information and the frame indices for frames having the asynchronously-multiplexed encoding information with decoding information, and to store the additional resume information to the interruption-information storage memory,
a signal processing section configured to perform decoding, and
a frame skip circuit configured to discard frames which do not need to be input to the signal processing section, and
the frame skip circuit determines whether or not to perform an input to the signal processing section based on the resume information stored in the interruption-information storage memory and the frame indices for the frames having the asynchronously-multiplexed encoding information in the additional resume information stored in the interruption-information storage memory, and skips and does not input into the signal processing section unnecessary encoded frames until the encoded frame corresponding to a frame index for the resume information is input.

6. The audio playback device of claim 5, wherein
the additional resume information extracted in the encoding-information analyze section includes both or either of the information stored in SBR headers of an AAC+SBR stream or the frame indices for frames having the headers.

7. The audio playback device of claim 5, wherein
the additional resume information extracted in the encoding-information analyze section includes frame indices for encoded frames including beginning portions of main data needed for decoding the frames of an MP3 stream, or frame indices for encoded frames having beginning portions of the main data therein.

8. An audio recording/playback device capable of recording and playing back a compressed audio stream constructed by multiplexing encoding information asynchronously with respect to encoded frames into the compressed stream generated by organizing a time series of digital audio signals into units of encoded frames, comprising:
a recording medium for recording the compressed audio stream;
an encoding-information index table configured to hold indices for frames into which encoding information is multiplexed asynchronously with respect to the encoded frames;
a compressed-stream encode means configured to encode the audio signals into the compressed audio stream, and to write frame-position information into the encoding-information index table when multiplexing the encoding information into the compressed stream;
a compressed-stream control means configured to calculate a compressed-audio-stream introduction position from both a playback position and the encoding-information index table;
a compressed-stream decode means configured to decode the compressed audio stream transmitted by the compressed-stream control means; and
an output control means configured to determine whether a decoding result should be output or not,
wherein
during playback, playback can be performed without any section not played back in terms of time and without any frequency range not played back even in playback from any position of the compressed audio stream, by controlling with the output control means so that the compressed audio stream transmitted by the compressed-stream control means is decoded by the compressed-stream decode means, and that the decoding result is output starting at a start position of playback.

9. The audio recording/playback device of claim 8, wherein
the compressed-stream decode means includes
an encoding-information detection section configured to detect asynchronously-multiplexed encoding information in the compressed audio stream, and to write a frame position thereof to the encoding-information index table, and
an index-table determination section configured to determine whether or not index information for the compressed audio stream to be decoded already exists in the encoding-information index table, and
playback can be performed without any section not played back in terms of time and without any frequency range not played back in playback from any position of the compressed audio stream during second or later playback, by adding the index information to the encoding-information index table by the encoding-information detection section if it is determined by the index-table determination section that the index information for the compressed audio stream to be decoded does not exist.

10. An audio playback apparatus comprising the device of any one of claims 1-9.

11. An audio playback method capable of playing back a compressed audio stream constructed by multiplexing encoding information asynchronously with respect to encoded frames into a compressed stream generated by organizing a time series of digital audio signals into units of encoded frames, comprising:
a step of recording a compressed audio stream on a recording medium;
a compressed-stream control step of holding frame information on the compressed audio stream at the time of an interruption of playback, calculating a start position of reading the compressed audio stream from the recording medium, and reading the compressed audio stream;
a compressed-stream decode step of decoding the compressed audio stream read by the compressed-stream control step, and generating additional resume information so as to include information at least enabling a determination whether a frame into which encoding information is asynchronously multiplexed has been decoded or not, of the decoding information obtained by decoding the frame;
an output control step of determining whether a decoding result should be output or not, and performing an output accordingly; and
a step of storing, to an interruption-information storage memory, resume information needed to restart playback upon the interruption of playback of the compressed audio stream,
wherein
when playback is restarted after the interruption, playback can be restarted without any section not played back in terms of time and without any frequency range not played back, by calculating a start position of reading the compressed audio stream based on both the additional resume information obtained by the compressed-stream decode step and the frame information at the time of the interruption, and by reading the compressed audio stream from the recording medium.

12. The audio playback method of claim 11, wherein
the compressed-stream control step includes
a compressed-stream read control step of reading the compressed audio stream from the recording medium upon receiving a playback start instruction or a playback restart instruction, and writing information on the stream being played back to the interruption-information storage memory upon receiving a playback interrupt instruction,
a start-position-of-playback control step of, if interruption information is stored in the interruption-information storage memory, instructing on a start position of reading the compressed audio stream from the recording medium in the compressed-stream read control step, and
an additional-resume-information write determination step of writing as appropriate the additional resume information to the interruption-information storage memory if the additional resume information transmitted to the interruption-information storage memory includes information enabling a determination whether a frame into which encoding information is asynchronously multiplexed has been decoded or not, and
a determination of the start position of reading by the start-position-of-playback control step and a determination of an output-start frame by the output control step are made upon a restart of playback based on the resume information and the additional resume information.

13. The audio playback method of claim 11, wherein
the compressed-stream decode step includes
an encoding-information analyze step of analyzing encoded frames in the compressed audio stream, extracting asynchronously-multiplexed encoding information, generating the additional resume information by combining either or both of the extracted encoding information or auxiliary decoding information obtained by the encoding information and the frame indices for frames having the asynchronously-multiplexed encoding information with decoding information, and storing the additional resume information to the interruption-information storage memory, and
a frame skip step of discarding frames which do not need to be input to a signal processing section configured to perform decoding, and
the frame skip step determines whether or not to perform an input to the signal processing section based on the resume information stored in the interruption-information storage memory and the frame indices for the frames having the asynchronously-multiplexed encoding information in the additional resume information stored in the interruption-information storage memory, and skips and does not input into the signal processing section unnecessary encoded frames until the encoded frame corresponding to a frame index for the resume information is input.

14. The audio playback method of claim 13, wherein
the additional resume information extracted in the encoding-information analyze step includes both the information stored in SBR headers of an AAC+SBR stream and the frame indices for frames having the headers, or the frame indices for frames having the headers.

15. The audio playback method of claim 13, wherein
the additional resume information extracted in the encoding-information analyze step includes frame indices for encoded frames including beginning portions of main data needed for decoding the frames of an MP3 stream, or frame indices for encoded frames having beginning portions of the main data therein.

16. An audio recording/playback method capable of recording and playing back a compressed audio stream constructed by multiplexing encoding information asynchronously with respect to encoded frames into the compressed stream generated by organizing a time series of digital audio signals into units of encoded frames, comprising:
a step of recording a compressed audio stream on a recording medium;
a step of holding, in an encoding-information index table, indices for frames into which encoding information is multiplexed asynchronously with respect to the encoded frames;
a compressed-stream encode step of encoding the audio signals into the compressed audio stream, and writing frame-position information into the encoding-information index table when multiplexing the encoding information into the compressed stream;
a compressed-stream control step of calculating a compressed-audio-stream introduction position from both a playback position and the encoding-information index table;
a compressed-stream decode step of decoding the compressed audio stream transmitted by the compressed-stream control step; and
an output control step of determining whether a decoding result should be output or not,
wherein
during playback, playback can be performed without any section not played back in terms of time and without any frequency range not played back even in playback from any position of the compressed audio stream, by controlling with the output control step so that the compressed audio stream transmitted by the compressed-stream control step is decoded by the compressed-stream decode step, and that the decoding result is output starting at a start position of playback.

17. The audio recording/playback device of claim 16, wherein
the compressed-stream decode step includes
an encoding-information detection step of detecting asynchronously-multiplexed encoding information in the compressed audio stream, and writing a frame position thereof to the encoding-information index table, and
an index-table determination step of determining whether or not index information for the compressed audio stream to be decoded already exists in the encoding-information index table, and
playback can be performed without any section not played back in terms of time and without any frequency range not played back in playback from any position of the compressed audio stream during second or later playback, by adding the index information to the encoding-information index table by the encoding-information detection step if it is determined by the index-table determination step that the index information for the compressed audio stream to be decoded does not exist.

18. An AV-stream playback device capable of playing back a multiplexed AV stream constructed by multiplexing both a compressed audio stream constructed by multiplexing encoding information asynchronously with respect to encoded frames into the compressed stream generated by organizing a time series of digital audio signals into units of encoded frames, and a compressed video stream generated by organizing a time series of digital video data into units of pictures, characterized in that:
when playback is restarted after an interruption, playback is restarted with a waveform extended to a right frequency range without any section not played back in terms of time at least for the audio signals based on information on a compressed audio stream recorded before the interruption.

19. The AV-stream playback device of claim 18, comprising:
a recording medium on which a multiplexed stream is recorded;
a multiplexed-AV-stream control means configured to hold frame information on a compressed audio stream before an interruption of playback, and configured to, when playback is restarted after the interruption, calculate a start position of reading the multiplexed AV stream from the recording medium based on additional resume information for determining whether or not a decoded audio frame has encoding information asynchronously multiplexed thereinto, on the audio frame information, and on compressed-video-stream resume information;
an AV demultiplexer means configured to demultiplex the multiplexed AV stream read by the multiplexed-AV-stream control means into a compressed audio stream and a compressed video stream;
a compressed-audio-stream decode means configured to decode the compressed audio stream demultiplexed by the AV demultiplexer means, and to transmit both the additional resume information generated from decoding information obtained by decoding the frame and the audio frame information to the multiplexed-AV-stream control means;
a compressed-video-stream decode means configured to decode the compressed video stream demultiplexed by the AV demultiplexer means, and to transmit the compressed-video-stream resume information to the multiplexed-AV-stream control means;
an audio-output control means configured to determine whether a decoding result of the compressed audio stream should be output or not, and to perform an output accordingly;
a video-output control means configured to determine whether a decoding result of the compressed video stream should be output or not, and to perform an output accordingly; and
an AV synchronization means configured to time-synchronize the decoding result of the compressed audio stream with the decoding result of the compressed video stream.

20. The AV-stream playback device of claim 18, comprising:
a recording medium on which a multiplexed AV stream is recorded;
a multiplexed-AV-stream control means configured to hold each of audio frame information and video frame information at the time of an interruption of playback, to calculate a start position of reading the multiplexed AV stream from the recording medium, and to read the multiplexed AV stream;
an AV demultiplexer means configured to demultiplex the multiplexed AV stream read by the multiplexed-AV-stream control means into a compressed audio stream and a compressed video stream;
a compressed-audio-stream decode means configured to decode the compressed audio stream demultiplexed by the AV demultiplexer means, to generate additional resume information so as to include information at least enabling a determination whether a frame into which encoding information is asynchronously multiplexed has been decoded or not, of the decoding information obtained by decoding the frame, and to transmit the additional resume information to the multiplexed-AV-stream control means;
a compressed-video-stream decode means configured to decode the compressed video stream demultiplexed by the AV demultiplexer means, and to transmit the compressed-video-stream resume information to the multiplexed-AV-stream control means;
an audio-output control means configured to determine whether a decoding result of the compressed audio stream should be output or not, and to perform an output accordingly;
a video-output control means configured to determine whether a decoding result of the compressed video stream should be output or not, and to perform an output accordingly;
an AV synchronization means configured to synchronize the decoding result of the compressed audio stream with the decoding result of the compressed video stream; and
an interruption-information storage memory configured to, upon an interruption of playback of the multiplexed AV stream, store both the compressed-audio-stream resume information needed for a restart of playback of the compressed audio stream and the compressed-video-stream resume information needed for a restart of playback of the compressed video stream,
wherein
when playback is restarted after the interruption, playback can be restarted without any section not played back in terms of time and without any frequency range not played back with respect to at least resume playback of audio streams, by calculating a position of the multiplexed AV stream including an audio frame needed for a restart of playback based on both the additional resume information transmitted from the compressed-audio-stream decode means and the frame information at the time of the interruption, and by reading the multiplexed AV stream from the recording medium.

21. The AV-stream playback device of claim 19 or 20, wherein
the multiplexed-AV-stream control means includes
a multiplexed-AV-stream read control means configured to read the multiplexed AV stream from the recording medium upon receiving a playback start instruction or a playback restart instruction, and to write information of the stream being played back to the interruption-information storage memory upon receiving a playback interrupt instruction,
a start-position-of-playback control means configured to, if interruption information is stored in the interruption-information storage memory, instruct the multiplexed-AV-stream read control means on a start position of reading the multiplexed AV stream from the recording medium,
an additional-resume-information write determination section configured to write as appropriate the additional resume information to the interruption-information storage memory if the additional resume information transmitted from the compressed-audio-stream decode means to the interruption-information storage memory with respect to resume playback information of a compressed audio stream includes information enabling a determination whether a frame into which encoding information is asynchronously multiplexed has been decoded or not, and
a determination of the start position of reading by the start-position-of-playback control means and a determination of an output-start frame by the audio-output control means are made upon restart of playback based on the compressed-audio-stream resume information and the additional resume information with respect to at least resume playback of audio.

22. The AV-stream playback device of claim 19 or 20, wherein
the compressed-audio-stream decode means includes
an encoding-information analyze section configured to analyze encoded audio frames, to extract asynchronously-multiplexed encoding information, to generate the additional resume information by combining either or both of the extracted encoding information or auxiliary decoding information obtained by the encoding information and the frame indices for frames having the asynchronously-multiplexed encoding information with decoding information, and to store the additional resume information to the interruption-information storage memory,
a signal processing section configured to perform decoding, and
a frame skip circuit configured to discard frames which do not need to be input to the signal processing section, and
the frame skip circuit determines whether or not to perform an input to the signal processing section based on the resume information stored in the interruption-information storage memory and the frame index for the frame having the asynchronously-multiplexed encoding information in the additional resume information stored in the interruption-information storage memory, and skips and does not input into the signal processing section unnecessary encoded frames until the encoded frame corresponding to a frame index for the resume information is input.

23. An AV-content playback apparatus comprising the device of any one of claims 18-22.
